(19) United States
(12) Patent Application Publication
(10) Pub. No.: US 2004/0241355 A1
(43) Pub. Date: Dec. 2, 2004

(54) Heat transfer sheet, image forming material, and image forming method

(75) Inventors: Shinichi Yoshinari, Shizuoka (JP); Mikio Totsuka, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/792,219

(22) Filed: Mar. 4, 2004

(30) Foreign Application Priority Data
Mar. 5, 2003 (JP) P. 2003-058581

(51) Int. Cl. B41M 5/40; B32B 27/30

(52) U.S. Cl. 428/32.87; 101/487

(57) ABSTRACT

A heat transfer sheet comprising a substrate, a light-heat conversion layer, and an image forming layer, wherein the image forming layer contains as a binder at least one of an acrylic resin and a styrene-acrylic copolymer resin, the acrylic resin and the styrene-acrylic copolymer resin having a glass transition temperature of 50° C. or lower and a minimum film-forming temperature of 50° C. or lower.

### FIELD OF THE INVENTION

This invention relates to a heat transfer sheet, an image forming material, and an image forming method which are used to form a full color image of high resolution with laser light. More particularly, the invention relates to a heat transfer sheet, an image forming material, and an image forming method which are useful to obtain a direct digital color proof (DDCP) in the field of printing or a mask image based on digital image signals by laser recording. The invention also relates to a heat transfer sheet material applicable to on-demand image recording and to an on-demand image forming method.

### BACKGROUND OF THE INVENTION

In the field of graphic arts, a printing plate is produced using a set of color separation films of a color original which are prepared using lithographic films. In general, a color proof is prepared from color separation films in order to inspect for errors in color separation and to check the need for color correction and the like before going to press. With the recent spread of computerized systems in prepress work, recording systems for preparing color proofs directly from digital signals, i.e., DDCP systems have been developed. With the advancement of desk-top publishing (DPT) environment, printing companies adopting a computer-to-plate (CTP) system have a strong demand for a DDCP system, which eliminates the need of intermediate film or plate output as has been involved in traditional analog proofing. In recent years, DDCPs with higher quality, higher stability, and larger sizes have been demanded as good approximations to the final prints. Such computerized systems, particularly contemplated for preparing high quality color proofs, generally use as a recording head a laser beam which is capable of modulation according to digital signals and focusing into a small spot diameter to reproduce dot images at 150 lines or more per inch.

Laser thermal transfer systems using a heat transfer sheet are capable of image formation at high resolution. The heat transfer sheet generally has, on a substrate, a light-heat conversion layer containing a light-heat converting substance capable of converting laser energy to heat, an image forming layer containing a colorant, and other optional layers such as a heat-sensitive release layer. Known laser thermal transfer systems include (1) laser sublimation, (2) laser ablation (see JP-A-6-219052), and (3) laser melt (see JP-A-5-58045). These image forming methods are advantageous in that stock paper having an image receiving layer (adhesive layer), which is actually used in printing, can be used as an image receiving material and that a multicolor image can easily be obtained by successively transferring images of different colors to an image receiving sheet. The methods furnish highly precise images with ease and are useful to prepare color proofs or high precision mask images. However, all these thermal transfer systems cannot get rid of the problem that the recorded dot shape is not sharp enough. Specifically, the laser sublimation system is insufficient in approximation in color to the final print results because of use of dyes as coloring matter. Besides, this system involving dye sublimation results in blurred dot outlines, failing to achieve sufficiently high resolution. The laser ablation system, which uses pigments as coloring matter, provides a satisfactory approximation in color to the final printed products. However, because of the involvement of coloring matter's scattering, the dots are blurred, resulting in insufficient resolution similarly to the dye sublimation system. The laser melt system also fails to create clear dot outlines because the molten colorant flows.

In addition to the above-described systems, a thin film transfer system using laser light has recently been proposed as means for transferring dots with clear outlines to give a transfer image of high resolution and high quality (see JP-A-2002-274051)

The layers constituting image forming materials used in the laser transfer system are generally formed using organic solvent type coating compositions. Nevertheless, waterborne coating compositions containing an aqueous binder are preferred for environmental considerations. With reference to heat sensitive transfer recording media having a release layer and a heat softening layer, such as an ink ribbon for thermal transfer, it is known that the heat softening layer can be provided by using a waterborne coating composition containing an aqueous binder (see JP-A-63-193886). However, no proposal has been made for an aqueous binder capable of forming an image forming layer with excellent performance as an image forming material according to a laser thermal transfer system.

Recently, on-demand printing by laser thermal transfer has been desired, in which a precise quantity of a heat transfer sheet is prepared when needed. On-demand printing utilizing an ink jet system or an electrophotographic system is known as means for providing more diversified customized service with smaller production lots (see JP-A-2002-154724). On-demand printing technology using a laser thermal transfer system for DDCPs has not been proposed as yet.

### SUMMARY OF THE INVENTION

An object of the present invention is to provide a heat transfer sheet which is prepared by using an aqueous binder and yet provides a high quality image at high sensitivity.

Another object of the invention is to provide a multicolor image forming material and a multicolor image forming method, with which to provide a high quality, high stability, and large size DDCP serving as a good approximation of final printed products.

Still another object of the invention is to provide a multicolor image forming material and a multicolor image forming method, with which to form a high quality image on an image receiving sheet with a stable transfer density even in high-energy laser recording with a multibeam laser writing system under varied temperature and humidity conditions.

Yet another object of the invention is to provide an image forming material and an image forming method which can provide a DDCP on demand.

To accomplish the above objects, the present invention provides, in its first aspect, a heat transfer sheet comprising a substrate having thereon at least a light-heat conversion layer and an image forming layer. The image forming layer contains as a binder an acrylic resin and/or a styrene-acrylic copolymer resin. The acrylic resin and the styrene-acrylic copolymer resin have a glass transition temperature (Tg) of 50° C. or lower and a minimum film-forming temperature (MFT) of 50° C. or lower.

The heat transfer sheet preferably has an intermediate layer farther from the substrate than the light-heat conversion layer.

The present invention also provides, in its second aspect, an image forming material comprising an image receiving sheet having an image receiving layer and the heat transfer sheet according to the present invention. The heat transfer sheet is adapted to be superposed on the image receiving sheet with the image forming layer facing the image receiving layer and irradiated with laser light to transfer the irradiated area of the image forming layer to the image receiving layer to record an image on the image receiving sheet.

The image recorded by using the image forming material preferably has a size of 515 mm by 728 mm or larger.

The present invention also provides, in its third aspect, a method of forming an image by using the image forming material according to the invention. The method includes the steps of superposing the heat transfer sheet of the invention on the image receiving sheet with the image forming layer of the heat transfer sheet facing the image receiving layer of the image receiving sheet, imagewise irradiating the superposed heat transfer sheet with laser light, and transferring the irradiated area of the image forming layer to the image receiving layer of the image receiving sheet in the form of a thin film to record an image.

The present invention also provides, in its fourth aspect, a coating composition for forming an image forming layer on a laminate sheet comprising a substrate, a light-heat conversion layer, and an intermediate layer in this order. The coating composition is adapted to be applied to the intermediate layer on demand for image recording. The coating composition contains a waterborne latex of an acrylic resin and/or a styrene-acrylic copolymer resin. The acrylic resin and the styrene-acrylic copolymer resin have a glass transition temperature (Tg) of 50° C. or lower and a minimum film-forming temperature (MFT) of 50° C. or lower.

The present invention also provides, in its fifth aspect, a method of forming an image on demand. The method includes the steps of applying the above-described coating composition to a laminate sheet to prepare a heat transfer sheet; superposing the heat transfer sheet on an image receiving sheet having an image receiving layer with the image forming layer facing the image receiving layer; imagewise irradiating the superposed heat transfer sheet with laser light; and transferring the irradiated area of the image forming layer to the image receiving layer of the image receiving sheet in the form of a thin film to record an image. The laminate sheet has a substrate, a light-heat conversion layer, and an intermediate layer in this order, and the coating composition is applied to the intermediate layer of the laminate sheet.

The present inventors previously studied to provide DDCPs of B2/A2 or larger sizes and even of B1/A1 or larger sizes while securing high image quality, high quality stability, and satisfactory level of approximation to a final output product. As a result, they developed a laser thermal transfer recording system for DDCP including (a) an image forming material characterized by capability of image transfer to the same material as stock (printing paper), capability of outputting true halftone dots, use of pigments as a colorant, and large sizes of B2 or larger, (b) an output device, and (c) high quality CMS (content management system) software. The performance features, system configuration, and technical key points of the laser thermal transfer recording system developed by the inventors are as follows. The performance features reside in (1) sharp dot formation, which offers a good approximation to final prints, (2) a satisfactory level of approximation in hue to final prints, and (3) stable proof quality owing to performance stability against variations of the environment (i.e., temperature and humidity) and repetition.

From the aspect of material design, technical key points that make this system work are establishment of thin film transfer technology and improvements on the heat transfer elements' capability of being tightly held on a recording drum by suction, capability of high-resolution recording, and heat resistance. More specifically, the developed thermal transfer recording system has been realized by (i) introduction of an infrared absorbing colorant, which permits thickness reduction of a light-heat conversion layer, (ii) introduction of a high-Tg polymer, which enhances heat resistance of a light-heat conversion layer, (iii) introduction of a heat-resistant pigment, which leads to hue stabilization, (iv) addition of a low-molecular component, such as a wax and an in organic pigment, which controls adhesion and cohesion, and (v) addition of a matting agent to a light-heat conversion layer, which ensures intimate contact to an image receiving sheet without causing image quality deterioration. From the aspect of apparatus design, on the other hand, technical key points that make this system work lie in (vi) an air ejection system adopted to a laser recording apparatus, with which a plurality of image receiving sheets having received an image can be stacked, (vii) the manner of inserting a sheet of printing paper and an image receiving sheet into a thermal transfer apparatus, in which the printing paper is superposed on the image receiving sheet placed with its image side up, which manner is effective to prevent the printing paper from curling after heat transfer, and (viii) connection to a general-purpose output drive which allows broadening of system configuration freedom. Thus, the laser thermal transfer recording system for DDCP the inventors developed is integration of various performance characteristics, system configuration, and the technical key points. This recording system is an illustrative example of means for carrying out the image forming method of the invention, and the present invention is not deemed to be limited thereto.

Material factors such as combinations of image forming elements (i.e., heat transfer sheets and an image receiving sheet), constituent layer configurations (e.g., a light-heat conversion layer, an image forming layer, and an image receiving layer), formulation of each element, and the like are not to function dependently but to be organically linked with each other. Furthermore, these image forming elements are to play their best performance when linked with a recording apparatus and a thermal transfer apparatus. The present inventors have continued their study based on this concept. They have thoroughly examined each layer of the image forming elements (inclusive of the transfer sheet and the image receiving sheet) and materials making up the layers. They have designed the layers constituting the image forming elements so that the constituent materials may be allowed to show their characteristics to the full. They have found proper ranges of various physical properties within which the image forming elements exert their full characteristics. As a result, the inventors have found out the best relations between physical properties and performance of the materials, layers, and sheets and succeeded in developing an image forming material which exhibits unexpectedly high performance when organically and systematically linked with a recording apparatus and a thermal transfer apparatus.

Significance of the present invention in the above-mentioned system developed by the inventors resides in offering an image forming material fit for the above-described system. In particular, the present invention is of high importance, providing a heat transfer sheet which has an image forming layer containing an aqueous binder and yet exhibits high sensitivity and high image quality, an image forming material including the heat transfer sheet, and an image forming method using the image forming material. The present invention is also of high value, providing a material and a method for image formation fit for on-demand printing for obtaining DDCPs in needed quantities when needed.

### BRIEF DESCRIPTION OF THE DRAWINGS

FIG. 1 (FIGS. 1A, 1B and 1C) shows a scheme for forming a multicolor image by thin film thermal transfer by laser beam.

FIG. 2 shows a configuration of a laser thermal transfer recording apparatus.

FIG. 3 shows a configuration of a thermal transfer apparatus.

FIG. 4 shows a system configuration including laser thermal transfer recording apparatus FINALPROOF.

### DETAILED DESCRIPTION OF THE INVENTION

The heat transfer sheet according to the invention contains in the image forming layer thereof an acrylic resin and/or a styrene-acrylic copolymer resin both of which have a Tg of 50° C. or lower, preferably 20° C. or lower, and a minimum film-forming temperature (MFT) of 50° C. or lower, preferably 20° C. or lower, as a binder. The binder is, while being aqueous, capable of forming an image forming layer with a satisfactory coating surface condition, and the resulting heat transfer sheet is capable of providing a high quality image at high sensitivity.

The image forming layer is formed by applying a coating composition containing a waterborne latex of the above-defined aqueous binder. The terminology “waterborne latex” as used herein denotes a system which is composed of a continuous phase containing water as a main solvent and a prescribed resin emulsified or suspended in the continuous phase as a disperse phase and which dries to form a film. Disperse systems which dry to form a film, such as waterborne emulsions and aqueous colloids, will be included under the category, “waterborne latex”. The waterborne latex used in the invention is not limited in process of preparation.

The coating composition for forming an image forming layer comprises not only the specified waterborne latex but a pigment described later and, if desired, other components including a wax and a plasticizer.

The thickness of the image forming layer of the heat transfer sheet is preferably 0.5 μm or smaller, still preferably 0.9 μm or smaller. The lower limit of the thickness is usually about 0.2 μm.

It is desirable for the image forming layer of the heat transfer sheet to have an optical density (OD_{I}) to thickness (T_{I}; unit: μm) ratio, OD_{I}/T_{I}, of 1.6 or higher, preferably 1.8 or higher, still preferably 2.50 or higher. The higher the ratio, the more desirable. Taking the balance with other characteristics into consideration, however, the upper limit of the ratio would be about 6 for the time being. The OD_{I}/T_{I} is a measure of transfer image density of the image forming layer and the resolution of the transfer image. The OD_{I}/T_{I} being in the recited range, a transfer image with a high density and a high resolution can be produced. A thinner image forming layer brings about increased color reproducibility.

The heat transfer sheet has a light-heat conversion layer on the substrate independently of the image forming layer to control color change and to assure color reproducibility.

The light-heat conversion layer preferably contains a polyamide-imide resin binder and a cyanine dye having a sulfonic acid group. A cyanine dye having a sulfonic acid group is characterized by high stability and insusceptibility to decomposition. When combined with a polyamide-imide resin binder, the cyanine dye is also characterized by its high affinity to the polyamide-imide resin so that it is prevented from migrating into the image forming layer, thereby suppressing color change between before and after the transfer to an image receiving layer. A combination of the polyamide-imide resin binder and the cyanine dye is also effective in assuring excellent stability of a coating composition for the light-heat conversion layer with time.

It is preferred for the light-heat conversion layer to have a surface gloss of 85 or higher, particularly 85 or higher and lower than 100, as represented in terms of Gs (60° C.) specified in JIS Z8741. With the surface gloss of the light-heat conversion layer adjusted within the above range, the image forming layer will have controlled surface properties to have adequate adhesion to an image receiving layer thereby providing good image quality. The surface gloss of the light-heat conversion layer can be adjusted by, for example, selection of the kind and amount of the matting agent to be added.

The difference in water content between the image forming layer and the image receiving layer of an image receiving sheet is preferably as small as possible. Specifically, the absolute difference in water content between these two layers at 19° C. and 30% RH is preferably 1.0% by weight or smaller, still preferably 0.5% by weight or smaller. It is also preferred that the absolute difference between the water content of the image forming layer at 19° C. and 30% RH and that of the image receiving layer at 27° C. and 70% RH be 1.0% by weight or smaller, particularly 0.5% by weight or smaller. These water contents are calculated from the weight difference between a subject layer having been conditioned in the recited atmosphere and the subject layer having been dried.

With the water content difference being in the above ranges, a better quality image can be produced in a more stable manner.

The film strength of the image forming layer is preferably such that the image forming layer having been transferred to an image receiving layer has a film strength of 200 g or higher as measured with a scratch tester. With this condition satisfied, the image on the image receiving sheet can be re-transferred to printing paper in a stable and successful manner.

It is desirable for the light-heat conversion layer of the heat transfer sheet to have an optical density (OD_{LH}) to thickness (T_{LH}; unit: μm) ratio, OD_{LH}/T_{LH}, of 4.36 or higher. The higher the ratio, the more desirable. Taking the balance with other characteristics into consideration, nevertheless, the upper limit of the ratio would be about 10 for the time being.

The OD_{LH} of the heat transfer sheet refers to the absorbance of the light-heat conversion layer at the peak wavelength of laser light used for recording. The absorbance is measured with a known spectrophotometer. A UV spectrophotometer “UV-240“supplied by Shimadzu Corp. was used in the invention. The ODLH is obtained by subtracting the optical density of the substrate from that of the laminate composed of the substrate and the light-heat conversion layer.

The OD_{LH}/T_{LH} relates to thermal conductivity in recording and is a measure greatly influential on the sensitivity and temperature- and humidity-dependence of recording. With the OD_{LH}/T_{LH} falling within the above-recited preferred range, the sensitivity of transfer to the image receiving sheet is increased, and recording dependence on environmental temperature and humidity is reduced. Specifically, the OD_{LH}/T_{LH} of 4.36 or higher provides a transfer image at a high resolution preferably of 2400 dpi or more, still preferably of 2600 dpi or more, and over a wide area as referred to inifra.

The thickness T_{LH} of the light-heat conversion layer is preferably 0.03 to 1.0 μm, still preferably 0.05 to 0.5 μm.

It is preferred for the image forming layer of the heat transfer sheet and the image receiving layer of the image receiving sheet to have a water contact angle of 7.0° to 120.0°, particularly 30.0° to 100.0°. The water contact angle is a measure of compatibility between the image forming layer and the image receiving layer, namely, transfer capabilities. In particular, the water contact angle of the image receiving layer is desirably 86° C. or smaller. With the contact angles falling in the recited ranges, the transfer sensitivity is improved, and temperature and humidity dependence of recording performance is reduced. In the invention, the water contact angles are measured with a contact angle meter CA-A supplied by Kyowa Interface Science Co., Ltd.

In the present invention, an image can be formed over a larger recording area than in conventional techniques by controlling the physical properties of the heat transfer sheet as described above. The image recording area achieved by the invention is preferably 515 mm by 728 mm (B2 size) or larger, still preferably 594 mm by 841 mm (A1 size) or larger. Accordingly, the size of the image receiving sheet is preferably 465 mm by 686 mm or larger.

As stated, the present invention provides an image forming material and an image forming method suited to on-demand production of DDCPs. The image forming material provided by the invention for on-demand applications includes a laminate sheet comprising a substrate, a light-heat conversion layer, and an intermediate layer and a coating composition for forming an image forming layer on the laminate sheet. On demand for image recording, the coating composition is applied to the intermediate layer of the laminate sheet to prepare a heat transfer sheet.

The laminate sheet can be used in common for preparing various heat transfer sheets different in color of the image forming layer. When needed, a coating composition of a needed hue is applied to the laminate sheet to obtain a heat transfer sheet of the needed hue. Accordingly, it is no more necessary to stock a large volume of heat transfer sheets for every color, which saves both labor and cost. The combination of the laminate sheet and the coating composition is particularly advantageous for preparing heat transfer sheets of diversified spot colors and for small production lots.

The total system, inclusive of the present invention, the present inventors have developed will be described hereunder. The system according to the present invention adopts the thin film thermal transfer system to accomplish high resolution and high image quality. The system is capable of producing a transfer image at a high resolution of 2400 dpi or more, preferably 2600 dpi or more. The thin film thermal transfer system is such that an image forming layer as thin as 0.01 to 0.9 μm is imagewise transferred to an image receiving sheet in the state not melted or hardly melted. In other words, the irradiated area of the image forming layer is transferred while keeping its shape as thin film so that an extremely high resolution is achieved. In a preferred method for effectively carrying out thin film transfer, the light-heat conversion layer is thermally deformed into a dome shape on being irradiated. The dome-shaped light-heat conversion layer pushes the image forming layer outward, whereby the image forming layer is brought into more intimate contact with the image receiving layer and transferred thereto easily. Great deformation generates a great force pushing the image forming layer toward the image receiving layer and results in easy transfer. Small deformation produces only a small pushing force and fails to accomplish perfect transfer. Hence, the deformation should be quantified as a measure of transfer capabilities. In the invention, the degree of deformation is represented by a deformation percentage obtained by dividing the sum of (a) the cross-sectional area of the layer after irradiation and (b) the cross-section area of the light-heat conversion layer before irradiation by the cross-section area (b) and multiplying the quotient by 100. That is, deformation percentage (%)={(a+b)/(b)}×100. The cross-sectional areas (a) and (b) are measured with a laser microscope VK8500 supplied by Keyence Corp. A deformation percentage preferred for thin film transfer is 110% or higher, preferably 125% or higher, still preferably 150% or higher. While the deformation percentage could exceed 250% as long as the light-heat conversion layer has an increased elongation at break, a preferred upper limit is usually about 250%.

The technical key points of image forming material which can be applied to the thin film thermal transfer recording system are (1) balancing between high-temperature response and storage stability, (2) securing intimate and full contact between the heat transfer sheet and the receiving sheet, (3) use of heat-resistant organic materials, and (4) securing surface cleanness, as hereinafter described.

(1) Balance Between High-Temperature Response and Storage Stability

The image forming layer must have a small thickness on the order of submicrons in order to attain high image quality on thin film transfer. However, the layer should contain a pigment in a high concentration enough to give a desired image density, which conflicts with fast thermal response. Besides, thermal response properties also conflict with storage (adhesion) stability. These conflicting problems are settled by development of novel polymers and additives.

(2) Vacuum Contact

In the thin film transfer technique in pursuit of high resolution, the transfer interface is desirably as smooth as possible. However, such surface smoothness interferes with sufficient vacuum contact. In the present invention, departing from the common knowledge relating to vacuum contact, a relatively large amount of a matting agent having a relatively small particle size is incorporated into a layer between the substrate and the image forming layer thereby to maintain a moderate uniform gap between the transfer sheet and the receiving sheet. As a result, vacuum contact capabilities are achieved without allowing the matting agent to cause dot missing and without ruining the advantages of the thin film transfer technology.

(3) Heat-Resistant Organic Materials

On irradiation, the light-heat conversion layer which converts laser light energy to heat energy reaches about 700° C., and the image forming layer containing a pigment reaches about 500° C. The inventors have developed a binder resin capable of being applied by organic solvent coating techniques as a material of the light-heat conversion layer. They have also developed a pigment as a colorant of the image forming layer which is more heat-resistant than pigments for printing, safe, and fit for color matching.

(4) Surface Cleanness

Dust or debris present between the transfer sheet and the receiving sheet leads to serious image defects in thin film transfer. To keep the image forming elements clean, material management alone is insufficient because dust outside the equipment can enter or dust can occur during sheet cutting operation. It has therefore been necessary to fit the equipment with a dust removing mechanism. The inventors have found a material with moderate tackiness with which the surface of the image forming elements can be cleaned. They have thus succeeded in dust removal without accompanying productivity reduction by using sheet feed rollers made of this material.

The whole system according to the invention will hereinafter be described. The present invention is contemplated to produce a heat transfer image of sharp dots, to re-transfer the transfer image to stock paper (paper actually used in printing), and to achieve recording over a wide area.

One of the performance features of the system developed by the inventors is capability of forming sharp dots. The resolution achievable with this system is 2400 dpi or higher, and a transfer image having a resolution according to a desired number of lines per inch (lpi) can be obtained by the system. The individual dots have very sharp edges substantially free from blur or deficiency. Full range of dots from highlights to shadows can be formed clearly. Therefore, the system is capable of outputting high quality dots at the same level of resolution as obtained with an image setter or a CTP setter to give a close approximation to dots and gradation of final printed products.

A second performance feature of the system is satisfactory cyclic reproducibility (repeatability). Since the image forming layer can be transferred in sharp dots, dots are reproduced in good agreement with a laser beam. Additionally, because of very small environmental dependency of recording characteristics, the results of repetition are stable in hue and density in a wide range of environmental conditions.

A third performance feature of the system is satisfactory color reproducibility. Since the system employs pigments in the image forming layer, which are used in printing inks, and has satisfactory cyclic reproducibility, highly accurate color management system (CMS) can be realized.

The heat transfer image obtained substantially matches the color hues of final prints, i.e., the hues of SWOP (specifications for web offset publications) colors or Japan-colors and shows the same change in what it looks like with a change of lighting (e.g., a fluorescent lamp and an incandescent lamp) as the final printed product.

A fourth performance feature of the system is satisfactory text quality. Owing to the sharp dot shape, the system reproduces fine lines of letters with sharp edges.

The material technology adopted to the laser thermal transfer recording system of the invention is then described. As previously noted, thermal transfer techniques for DDCPs include laser sublimation, laser ablation, and laser melt. The laser sublimation system and the laser ablation system result in blurred dot edges because of sublimation or scattering of a colorant. The laser melt system also fails to create clear dot outlines because the molten colorant flows. The system according to the invention adopts the thin film thermal transfer system. In order to solve problems associated with the laser thermal transfer systems and to further improve the transfer image quality, the following material techniques have been added to the thin film transfer system.

A first material feature of the system is a sharper dot edge. In thermal transfer recording, laser light is converted to heat in the light-heat conversion layer, the heat is transmitted to the adjoining image forming layer, and the image forming layer adheres to the image receiving layer to conduct recording. In order to make sharp dots, it is required that the heat generated by laser light be transmitted right to the transfer interface without being diffused in the planar direction so that the image forming layer may be cut sharply along the borders between heated areas and non-heated areas. For this purpose, the light-heat conversion layer of the heat transfer sheet should be reduced in thickness, and the dynamic characteristics of the image forming layer should be so controlled.

Accordingly, a first technique for accomplishing dot sharpening is thickness reduction of the light-heat conversion layer. As simulated, a light-heat conversion layer is assumed to instantaneously reach about 700° C. so that a thin light-heat conversion layer is liable to deformation or destruction. A deformed or destroyed thin light-heat conversion layer would be transferred to an image receiving sheet together with an image forming layer or result in an uneven transfer image. Beside this problem, a light-heat conversion layer must have a light-heat converting substance in a high concentration so as to reach a prescribed temperature, which can cause additional problems such as colorant's precipitation or migration to an adjacent layer. To address these problems, the heat transfer sheet of the invention employs an infrared absorbing colorant as a light-heat converting substance which is effective at a reduced amount compared with carbon that has been often used as a light-heat converting substance. With respect to a binder, a resin which retains sufficient mechanical strength even at high temperatures and has satisfactory ability to hold an infrared absorbing colorant is selected.

In this way, it is preferred to reduce the light-heat conversion layer thickness to about 0.5 μm or smaller by selecting an infrared absorbing colorant exhibiting excellent light-heat conversion characteristics and a heat-resistant binder such as polyimide or polyamide-imide.

The combined use of the infrared absorbing colorant and the polyamide-imide resin in the light-heat conversion layer produces the following effects. The storage stability of a coating composition for light-heat conversion layer is improved thereby to prevent reduction in absorbance of the light-heat conversion layer that might occur due to storage of the coating composition. The absorbance of the light-heat conversion layer is increased, which leads to improved sensitivity. Change in hue after irradiation is reduced to improve light fastness of the transferred image.

A second technique for dot sharpening is for improving the characteristics of the image forming layer. If the light-heat conversion layer is deformed, or if the image forming layer itself undergoes deformation due to high heat, the image forming layer transferred to the image receiving layer suffers from thickness unevenness in response to the slow scanning pattern of a laser beam. It follows that the transfer image becomes non-uniform, and the apparent transfer density reduces. This tendency becomes conspicuous with a decrease in image forming layer thickness. On the other hand, a thick image forming layer has poor dot sharpness and reduced sensitivity.

In order to solve these problems, it is preferred to reduce transfer unevenness by adding a low-melting substance, such as a wax, to the image forming layer. Furthermore, part of the binder can be replaced with fine inorganic particles to increase the layer thickness to a proper degree so that the image forming layer may be sharply cut along the heated area/non-heated area borders. As a result, uniform recording can be accomplished without impairing dot sharpness and sensitivity.

In general, low-melting substances such as waxes tend to bleed on the surface of the image forming layer or to crystallize, which can result in impairment of image quality or deterioration of stability of the heat transfer sheet with time. To avert this drawback, it is preferred to select a low-melting substance with a small difference in Sp (solubility parameter) value from the polymer of the image forming layer. Such a substance exhibits improved compatibility with the polymer and is prevented from releasing from the image forming layer. It is also preferred for avoiding crystallization to use an eutectic mixture of low-melting substances having different structures. By these manipulations an image of sharp dots free from unevenness can be obtained.

A second material feature of the system lies in improvement on hue approximation to the final output. The system of the invention has introduced the knowledge about color matching management and stable dispersing technique amassed through the development of a thermal head type color proofer (e.g., First Proof supplied by Fuji Photo Film Co., Ltd.) and also settled the following problem that has arisen in the laser thermal transfer system.

A first technique for achieving improved hue approximation to the final output consists in use of a highly heat-resistant pigment. An image forming layer generally reaches about 500° C. in laser thermal transfer recording. Some of traditionally employed pigments decompose at such high temperatures. This problem is settled by using highly heat-resistant pigments in the image forming layer.

A second technique realizing improved hue approximation to the final output resides in prevention of the infrared absorbing colorant from diffusing. If the infrared absorbing colorant used in the light-heat conversion layer migrates to the image forming layer due to the high recording heat, it follows that the hue of a resultant transfer image differs from what is expected. To prevent this, the light-heat conversion layer is preferably made of the infrared absorbing colorant combined with the above-described binder capable of securely holding the infrared absorbing colorant.

A third material feature of the system is improvement on vacuum holding. The image receiving sheet and the heat transfer sheet are preferably held on a recording drum by vacuum holding. The contact of the two sheets by vacuum holding is of great significance because image transfer relies on control of adhesion between the image receiving layer of the image receiving sheet and the image forming layer of the transfer sheet, and the transfer behavior is very sensitive to the clearance therebetween. An increased gap between the two sheets due to dust or debris results in image defects or transfer unevenness. To prevent such image defects and transfer unevenness, it is preferred to give uniform surface roughness to the heat transfer sheet thereby allowing entrapped air to escape to make a uniform clearance between the two sheets.

Surface roughness is given to the heat transfer sheet side so that the effect of vacuum contact may be fully enjoyed when two or more color images are overprinted. The heat transfer sheet can be textured by post-treatments such as embossing or addition of a matting agent. Addition of a matting agent is preferred for the sake of process simplification and in view of material stability with time. A matting agent to be added should have a particle size larger than the thickness of a layer to which it is added. Addition of a matting agent directly to the image forming layer would result in missing of dots from the part where the matting agent particles stick out. Therefore, a matting agent of optimum particle size is preferably added to the light-heat conversion layer. As a result, the image forming layer provided thereon has an almost uniform thickness and is capable of transferring a defect-free image to the image receiving sheet.

The systematization of the technique according to the present invention will then be described.

A first feature of the systematization is configuration of the recording apparatus. In order to duly reproduce sharp dots, not only the image forming material but also the recording apparatus should be designed precisely. The recording apparatus which can be used has the same basic configuration as conventional thermal transfer recorders. This configuration is a so-called heat mode outer drum recording system in which a heat transfer sheet and an image receiving sheet held on a drum are irradiated with a recording head having a plurality of high power lasers. The following embodiments are preferred among others.

Firstly, the recording apparatus is designed to avoid contamination with dust. The image receiving sheet and the heat transfer sheet are supplied by a full-automatic roll supply system so as to avoid contamination with dust or debris that might enter if the recording apparatus is manually loaded with a stack of cut sheets. A loading unit containing rolls of the heat transfer sheets of different colors, one roll for one color, rotates to bring each roll to the position where the unrolled continuous sheet is cut at a prescribed length with a cutter, and the cut sheet is held onto a recording drum.

Secondly, the recording apparatus is designed to bring the image receiving sheet and the heat transfer sheet into intimate contact on the recording drum. The image receiving sheet and the heat transfer sheet are held to the drum by suction (vacuum holding). Mechanical holding fails to bring the two sheets into such intimate contact as obtained by vacuum holding. A large number of suction holes are formed on the recording drum, and the inside of the drum is evacuated with a blower or a vacuum pump thereby to hold the sheets onto the drum. The image receiving sheet is the first to be held by suction, and the heat transfer sheet is superposed thereon. Therefore, the heat transfer sheet is made larger than the image receiving sheet so as to have extensions over every side of the image receiving sheet. Air between the heat transfer sheet and the image receiving sheet, which greatly influences the image transfer, is sucked from the extension area of the heat transfer sheet extending from the underlying image receiving sheet.

Thirdly, the recording apparatus is designed to allow a plurality of output sheets to be stacked stably on an output tray. In the present invention, the recording apparatus is contemplated to provide output sheets of B2 or larger sizes being stacked on the output tray. When a sheet is outputted and superposed on another sheet that has already been discharged, the two sheets can stick to each other because of the heat stickiness of the image receiving layer. If this happens, the next sheet is not discharged in good order to cause jamming. To prevent this from happening, it is the best to prevent the output sheets from coming into contact with each other. Known means for preventing the contact include (a) a level difference made on the output tray, by which the sheet is placed non-flat, and a gap is created between adjacent sheets, (b) a slot for output exit positioned higher than the output tray so that an output sheet discharged through the slot drops on the output tray, and (c) air ejected between adjacent sheets to float the upper sheet. Since the sheet size is as large as B2, application of the means (a) or (b) will make the apparatus considerably larger. Therefore, the means (c), i.e., an air ejection method is employed in this system.

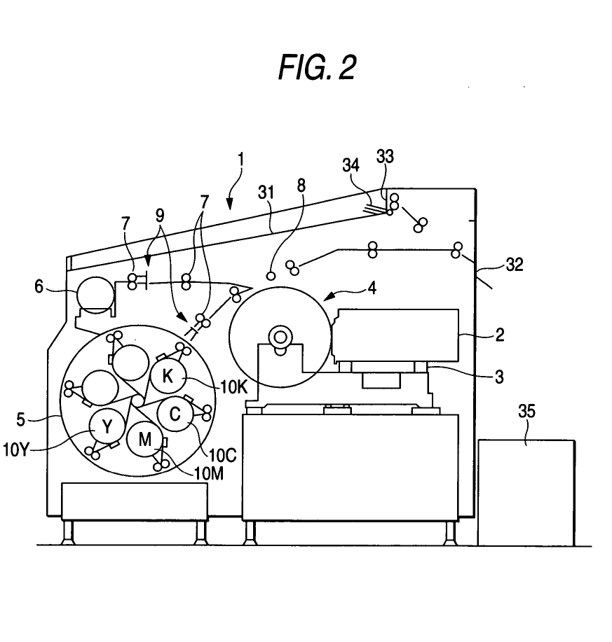

FIG. 2 shows a recording apparatus 1 as an example of the recording apparatus which can be used in the invention.

Referring to FIG. 2, steps for full color image formation by use of the image forming material according to the invention and the above-described recording apparatus are illustrated below in sequence.

1) A recording head 2 which slides on rails 3 in the slow scan (sub-scan) direction, a recording drum 4 which rotates in the fast scan (main scan) direction, and a heat transfer sheet loading unit 5 return to their starting positions.

2) An image receiving sheet is unrolled from an image receiving sheet roll 6 with feed rollers 7, and the leading end of the image receiving sheet is fixed by suction onto the recording drum 4 through suction holes of the recording drum.

3) A squeegee roller 8 comes down and presses the image receiving sheet to the recording drum 4. In this state, the drum 4 rotates to further unroll the image receiving sheet. When a given length is unrolled, the drum stop rotating, and a cutter 9 cuts the unrolled sheet.

4) The recording drum 4 further turns to makes one revolution to complete image receiving sheet loading.

5) A heat transfer sheet of the first color, e.g., black (K), is unrolled from a heat transfer sheet roll 10K, held onto the recording drum 4, and cut into a sheet of prescribed length according to the same sequence as for the image receiving sheet.

6) The recording drum 4 starts to rotate at high speed, and the recording head 2 starts to move on the rails 3. When the recording head 2 arrives at a record starting position, it emits writing laser beams to irradiate the transfer material (heat transfer sheet and the image receiving sheet) held on the recording drum 4 according to recording signals. The irradiation is stopped at a recording terminal position, and the operations of the rails 3 and the drum 4 stop. The recording head 2 on the rails 3 returns to its starting position.

7) Only the heat transfer sheet K is peeled off with the image receiving sheet left on the recording drum. The leading end of the heat transfer sheet K is caught in claws, pulled apart from the image receiving sheet, and discarded through a discard slot 32 into a waste box 35.

8) The steps (5) to (7) are repeated for each of the other heat transfer sheets. Recording is performed in the order of, for example, black (K), cyan (C), magenta (M), yellow (Y), and other optional colors. That is, for example, a heat transfer sheet of the second color (C), a heat transfer sheet of the third color (M), a heat transfer sheet of the fourth color (Y), and, if desired, a heat transfer sheet of the fifth color (R) are successively fed from rolls 10C, 10M, 10Y, and 10R, respectively. The order of color superimposition in the recording apparatus is the reverse of the general printing order because the resulting color image is reversed on re-transfer to paper to give a color proof. The order of color superimposition is not particularly limited.

9) After completion of the above steps, the recorded image receiving sheet is discharged on an output tray 31. The image receiving sheet is separated from the recording drum in the same manner as for the heat transfer sheets (as described in step (7)) but is not discarded. When it comes near the discard slot 32, it changes its direction by a switchback mechanism and is forwarded to the output tray. When the image receiving sheet exits through the discharge slot 33, air 34 is blown from under the slot 33 to allow a plurality of sheets to be stacked without sticking to each other.

When image formation is effected on demand, a coating composition for image forming layer is applied to the intermediate layer of a laminate sheet to prepare a heat transfer sheet having an image forming layer of desired hue. Thereafter, an image is formed in accordance with the sequence described above using the thus prepared heat transfer sheet. The on-demand image forming method eliminates the necessity to stock a large volume of heat transfer sheets having the respective image forming layers. This is particularly advantageous where heat transfer sheets of a wide variety of colors are required in small lots.

Application of the coating composition to an intermediate layer is carried out by blade coating, roll coating, bar coating, curtain coating, gravure coating or like coating techniques.

It is preferred to use an adhesive roller as one of paired feed rollers 7 disposed on any site between the recording drum 4 and each of the image receiving sheet roll and the heat transfer sheet roll to clean the surface of the heat transfer sheet and the image receiving sheet.

The adhesive roller has a sticky material on its surface. The sticky material includes an ethylene-vinyl acetate copolymer, an ethylene-ethyl acrylate copolymer, a polyolefin resin, a polybutadiene resin, a styrene-butadiene copolymer (SBR), a styrene-ethylene-butene-styrene copolymer (SEBS), an acrylonitrile-butadiene copolymer (NBR), a polyisoprene resin (IR), a styrene-isoprene copolymer (SIS), an acrylic ester copolymer, a polyester resin, a polyurethane resin, an acrylic resin, butyl rubber, and polynorbornene.

The surface of the heat transfer sheet and the image receiving sheet can be cleaned on contact with the adhesive roller. The contact pressure is not particular limited.

It is preferred that the sticky material used in the adhesive roller has a Vickers hardness Hv of 50 kg/mm² (≈490 MPa) or less for thoroughly removing dust and thereby preventing image defects caused by dust. “Vickers hardness” is a hardness measured by applying a static load to a quadrangular pyramidal diamond indenter having an angle of 136° between the opposite faces. Vickers hardness Hv is obtained from equation:

Hv=1.854P/d² (kg/mm²)≈18.1692P/d² (MPa)

where P is a load (kg) applied, and d is the length (mm) of a diagonal of a square indentation.

It is also preferred for the sticky material to have an elastic modulus of 200 kg/cm² (≈19.6 MPa) or less at 20° C. for the same purpose as described above.

A second feature of the systematization is configuration of a thermal transfer apparatus. A thermal transfer apparatus is used to carry out the step of re-transferring the transfer image on the image receiving sheet to a sheet of the same paper as used in final printing (hereinafter simply referred to as a paper sheet). This step is entirely identical to that carried out in First Proof (a trade mark of a thermal transfer apparatus available from Fuji Photo Film Co., Ltd.). A paper sheet is superposed on the image receiving sheet, and heat and pressure are applied thereto to adhere the two sheets together. Then, the image receiving sheet is stripped off the paper sheet, whereby only the substrate and a cushioning layer (if provided as hereinafter described) of the image receiving sheet are removed to leave the image and the image receiving layer on the paper sheet. This practically means that the image is transferred from the image receiving sheet to the printing paper sheet.

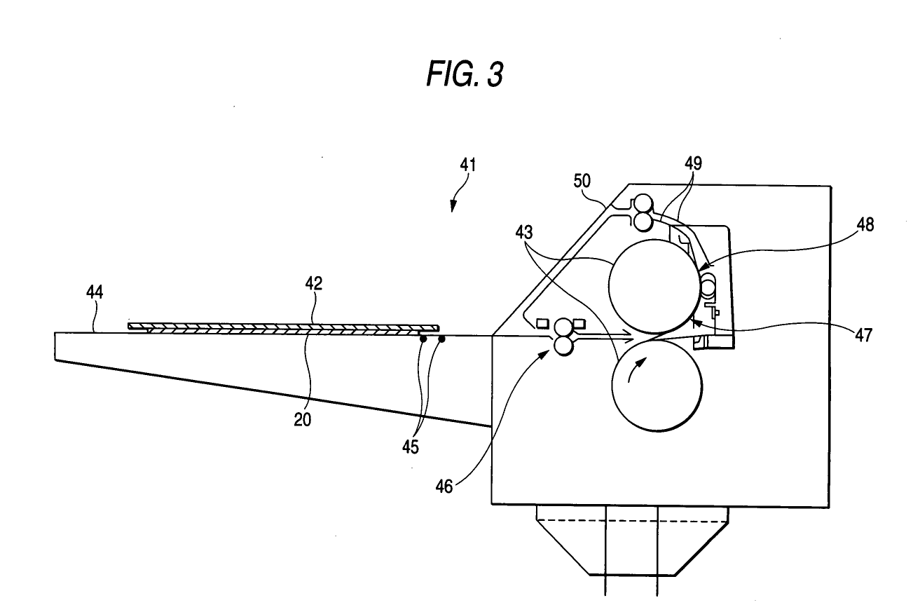

In First Proof™, image re-transfer is performed by superposing a paper sheet and the image receiving sheet on an aluminum guide plate and passing them through a pair of heat rollers. The aluminum guide plate serves to prevent the paper from deformation. If this design is applied as such to the system for B2 size output, the aluminum guide plate should be larger than a B2 size, which results in the problem that a large installation space is required. Accordingly, the system of the present invention does not use such an aluminum guide plate. Instead, the carrier path turns 180° so that the sheets are discharged toward the loading side. As a result, the installation space can be largely saved (see FIG. 3). However, there arises another problem that the paper sheet is curled in the absence of an aluminum guide plate. The facing couple of the paper sheet and the image receiving sheet curls with the image receiving sheet inward and rolls on the output tray. It is very difficult to separate the image receiving sheet from the curled paper.

In the present invention, this curling phenomenon is averted by taking advantage of bimetallic effect due to the difference in shrinkage between printing paper and the image receiving sheet and the ironing effect of the heat roller. Where an image receiving sheet is superposed on a paper sheet as in a conventional way, the two sheets curl with the image receiving sheet inward by bimetallic effect upon heating because the image receiving sheet shows larger thermal shrinkage in the direction of insertion than printing paper. The direction of curling by the bimetallic effect is the same as the direction of curling by the ironing effect of the heat roller around which the two sheets are wound. As a result, the curling becomes serious by synergism. In contrast, when the paper sheet is superposed on an image receiving sheet, downward curling by the bimetallic effect occurs whereas upward curling is caused by ironing effect so that the curls of opposite directions are offset by each other.

Re-transfer to a printing paper sheet is carried out according to the following sequence. A thermal transfer apparatus 41 which can be used for re-transfer is shown in FIG. 3. Unlike the laser recording apparatus, the thermal transfer apparatus 41 is manually operated.

1) To begin with, dials (not shown) are turned to set the temperature of heat rollers 43 (variable between 100° and 110° C.) and the transfer speed according to the kind of printing paper sheet 42.

2) An image receiving sheet 20 is put on an insertion table 44 with the image side up, and the dust on the image is removed by an antistatic brush (not shown). A paper sheet 42 from which dust has been removed is superposed thereon. Because the upper paper sheet 42 is larger than the lower image receiving sheet 20, it is difficult to position the paper sheet 42 on the image receiving sheet 20 hidden from the eye. For improving the ease of the positioning work, marks 45 indicating the positions of placement for an image receiving sheet and a paper sheet are made on the insertion table 44. The reason the paper sheet is larger than the image receiving sheet 20 is to prevent image receiving sheet 20 from coming out under the paper sheet 42 and staining heat roller 43.

3) The image receiving sheet and the paper sheet are inserted into an insert port, and a pair of insert rollers 46 rotate to forward them to heat rollers 43.

4) When the leading end of the paper sheet 42 reaches the heat rollers 43, the heat rollers nip the two sheets to start heat transfer. The heat rollers are heat resisting silicone rubber rollers. Pressure and heat are applied simultaneously to the image receiving sheet and the paper sheet to adhere them. A heat-resistant guide sheet 47 is provided by the side of the upper heat roller. The image receiving sheet and the paper sheet are carried upward through between the upper heat roller and the guide sheet 47 while being heated, separated from the upper heat roller by separation claws 48, and guided to an output slot 50 along a pair of guide plates 49.

5) The image receiving sheet and the paper sheet coming out of the output slot 50 is discharged on the insertion table while being adhered. Thereafter, the image receiving sheet 20 is separated from the paper sheet 42 by the hand.

The third feature of the systematization technique resides in the system configuration.

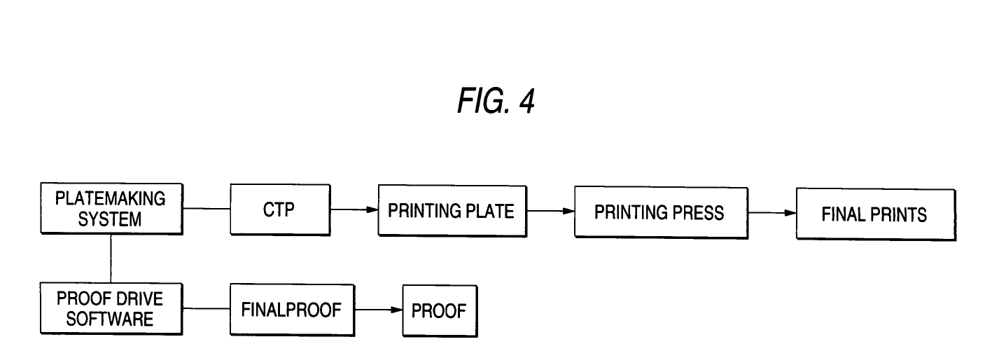

The above-illustrated apparatus are connected to a plate-making system to perform the function as a color proofer. A color proofing system is required to output a color proof as an approximation to final prints outputted based on certain page data. Therefore, software for approximating dots and colors to the final prints is necessary. A specific example of connection is shown below. FIG. 4 is referred to.

When a proof is to be prepared for the final printing product outputted from a plate-making system Celebra™ (from Fuji Photo Film Co., Ltd.), a CTP system is connected to Celebra. A printing plate outputted from this connection is mounted on a press to carry out actual printing. To Celebra is connected the above-illustrated thermal transfer recording apparatus as a color proofer, e.g., Luxel FINALPROOF 5600 from Fuji Photo Film Co., Ltd. (hereinafter simply referred to as FINALPROOF), and proof drive software PD SYSTEM™ available from Fuji Photo Film is installed between Celebra and FINALPROOF for approximating dots and colors to the final output.

Contone data (continuous tone data) converted to raster data by Celebra are converted to binary data for dots, outputted to the CTP system, and finally printed. On the other hand, the same contone data are also sent to PD SYSTEM. PD SYSTEM converts the received data according to a multi-dimensional table for each color so that the colors may agree with the final output. Finally the data are converted to binary data for dots so as to agree with the dots of the final output, which are sent to FINALPROOF.

The multi-dimensional table for each color is experimentally prepared in advance and stored in the system. The experiment for the preparation of the multi-dimensional table is as follows. Date of an important color are outputted via the CTP system to prepare a printed image. The same data are also outputted from FINALPROOF via PD SYSTEM to prepare a proof image. The measured color values of these images are compared, and a table is prepared so as to minimize the difference.

Thus, the system configuration is set up so that the performance of the high-resolution image forming material of the invention may be exhibited to the full.

The heat transfer sheet suitably used in the above-described system is then described.

It is preferred that the absolute value of the difference in surface roughness Rz (defined later) between the exterior and the interior sides of the image forming layer of the heat transfer sheet be 3.0 μm or smaller and that the absolute value of the difference in surface roughness Rz between the exterior and the interior sides of the image-receiving layer of the image receiving sheet be 3.0 μm or smaller. Such a layer design combined with the above-described cleaning means prevents image defects and jamming in the sheet path and reduces variations in dot gain.

The surface roughness Rz is a 10 point height parameter corresponding to the Rz (maximum height) specified in JIS B 0601. The surface roughness Rz is obtained by computing the average height difference between the five highest peaks and the five lowest valleys with respect to the mean plane within an evaluation area. A stylus type 3D roughness meter (Surfcom 570A-3DF, available from Tokyo Seimitsu Co., Ltd.) is used for measurement. The measurement is performed in the longitudinal direction, the cut-off length is 0.08 mm, the evaluation area is 0.6 mm by 0.4 mm, the sampling pitch is 0.005 mm, and the speed of measurement is 0.12 mm/sec.

For enhancing the above-described effects, it is still preferred that the absolute difference in Rz between the exterior and the interior surfaces of the image forming layer be 1.0 μm or smaller and that the absolute difference in Rz between the exterior and the interior sides of the image receiving layer be 1.0 μm or smaller.

In another layer design, it is preferred that the surface roughness Rz of both the exterior and the interior sides of the image forming layer of the heat transfer sheet and/or both the exterior and the interior sides of the image receiving layer of the image receiving sheet be in a range of from 2 to 30 μm. Such a surface profile combined with the above-described cleaning means prevents image defects and jamming in the sheet path and reduces variations in dot gain.

It is preferred for the image forming layer of the heat transfer sheet to have a surface gloss of 80 to 99. The surface gloss of the image forming layer largely depends on the smoothness of the layer and relates to the thickness uniformity of the layer. An image forming layer with a higher surface gloss has higher thickness uniformity and is more suited for high precision image formation. However, higher smoothness leads to higher resistance in sheet transportation. That is, the smoothness and ease of transportation conflict with each other. Where the surface gloss ranges 80 to 99, a good balance between smoothness and ease of transportation will be achieved.

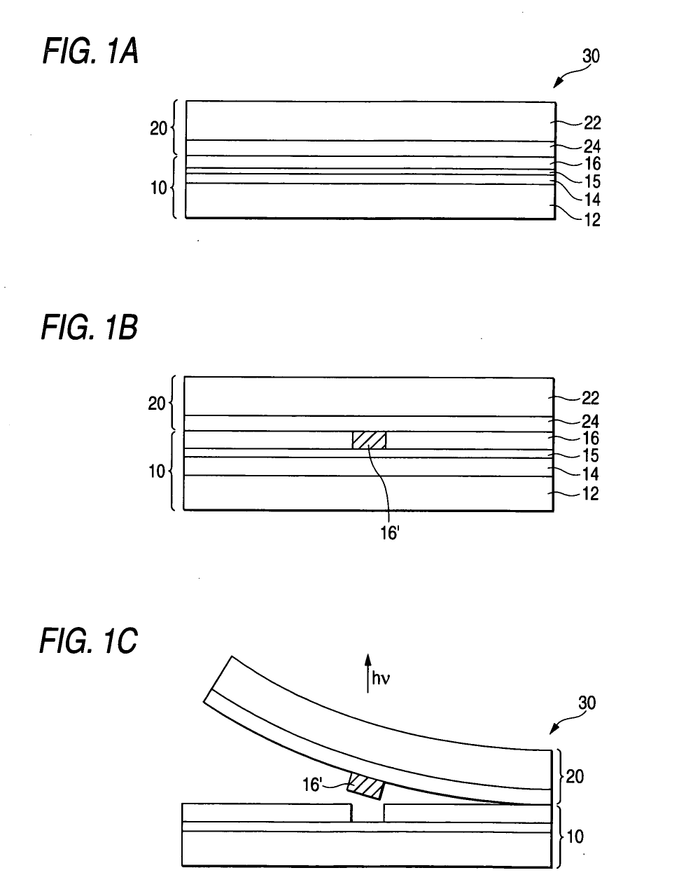

The scheme of image formation by thin film thermal transfer using a laser is described by referring to FIG. 1.

An image forming laminate 30 composed of a heat transfer sheet 10 and an image receiving sheet 20 is prepared (see FIG. 1A). The heat transfer sheet 10 has a substrate 12, a light-heat conversion layer 14 provided on the substrate 12, and an image forming layer 16 containing a pigment (black (K), cyan (C), magenta (M), yellow (Y), etc.) provided on the light-heat conversion layer 14. The image receiving sheet 20 has a substrate 22 and an image receiving layer 24. The two sheets 10 and 20 are superposed with the image receiving layer 24 facing the image forming layer 16. On imagewise irradiating the laminate 30 with a laser beam from the side of the substrate 12 of the heat transfer sheet 10 in a time series, the irradiated area of the light-heat conversion layer 14 of the heat transfer sheet 10 generates heat to reduce its adhesion to the image forming layer 16 (see FIG. 1B). The heat transfer sheet 10 is stripped off the image receiving sheet 20 while leaving the irradiated area 16′ of the image forming layer 16 on the image receiving layer 24 of the image receiving sheet 20. That is, the image is transferred (see FIG. 1C).

The laser light for imagewise irradiation is preferably multi-beam light, particularly multibeams of two-dimensional array. Multibeams of two-dimensional array are a plurality of laser beams arranged in a two-dimensional array such that the spots of these laser beams form a plurality of lines in the fast scan direction and a plurality of rows in the slow scan direction. Use of multibeams in a two-dimensional array reduces the time required for laser recording.

Laser beams of any kind can be used in recording with no limitation, including direct laser beams such as gas laser beams, e.g., an argon ion laser beam, a helium neon laser beam, and a helium cadmium laser beam, solid state laser beams, e.g., a YAG laser beam, a semiconductor laser beam, a dye laser beam, and an excimer laser beam. Light rays obtained by converting these laser beams to half the wavelength through a second harmonic generation device can also be used. In multicolor image formation, semiconductor laser beams are preferably used taking the output power and ease of modulation into consideration. In multicolor image formation, a laser beam is preferably emitted to give a spot diameter of 5 to 50 μm, particularly 6 to 30 μm, on the light-heat conversion layer. The scanning speed is preferably 1 m/sec or higher, still preferably 3 m/sec or higher.

In multicolor image formation, the thickness of the black image forming layer in the black heat transfer sheet is preferably larger than that of the other image forming layers of the other heat transfer sheets (e.g., yellow, magenta, cyan, etc.) and preferably ranges from 0.5 to 0.7 μm. This layer thickness design is effective to prevent density reduction due to non-uniform transfer of the black image forming layer. With the thickness being 0.5 μm or greater, the black image forming layer can be uniformly transferred when recorded with high energy thereby attaining a satisfactory image density necessary as a color proof for printing. Since the tendency to transfer unevenness becomes outstanding under high humidity conditions, the thickness of 0.5 μm or greater is particularly effective to reduce environment-induced variations in density. On the other hand, the black image forming layer thickness of 0.7 μm or smaller is effective in maintaining the transfer sensitivity in laser recording and improving reproducibility of small dots and fine lines. These effects are more conspicuous under low humidity conditions. Resolution can also be improved with the above layer thickness. The layer thickness of the black image forming layer of the black heat transfer sheet is still preferably 0.55 to 0.65 μm, particularly preferably 0.58 to 0.62 μm.

In addition to the black image forming layer thickness ranging 0.5 to 0.7 μm, it is preferred that the thickness of the image forming layers of other heat transfer sheets (e.g., yellow, magenta, cyan, etc.) be from 0.2 to less than 0.5 μm. The 0.2 μm or greater thickness of these image forming layers (e.g., yellow, magenta, cyan, etc.) is effective to prevent transfer unevenness thereby to maintain the image density in laser recording. With the thickness of these color image forming layers being less than 0.5 μm, the transfer sensitivity and resolution are improved. A still preferred thickness of these image forming layers is from 0.3 to 0.45 μm.

The black image forming layer of the black heat transfer sheet preferably contains carbon black. The carbon black to be used preferably comprises at least two kinds different in tinting strength from the viewpoint of ease of controlling reflection density while maintaining a pigment/binder ratio within a specific range.

The tinting strength of carbon black can be represented in various terms. PVC blackness disclosed in JP-A-10-140033 is among them. PVC blackness of carbon black is determined as follows. Carbon black to be evaluated is dispersed in a polyvinyl chloride resin by a two-roll mill and molded into a sheet. The blacknesses of Carbon Black #40 and #45, both available from Mitsubishi Chemicals Co., Ltd. being taken as 1 point and 10 points, respectively, the PVC blackness of the sample sheet is rated by visual observation on a 10 point scale. Two or more carbon blacks having different PVC blacknesses can be used in an appropriate combination according to the purpose.

Preparation of Sample:

The following components are kneaded in a 250 cc Banbury mixer at 115° C. for 4 minutes to prepare a master batch having a carbon black content of 40% by weight.

Master batch formulation:

| | |
|---|---|
| Low-density linear polyethylene (LDPE) | 101.89 g |
| Calcium stearate | 1.39 g |
| Irganox 1010 | 0.87 g |
| Carbon black | 69.43 g |

The master batch is diluted according to the following formulation in a two-roll mill at 120° C. to prepare a compound having a carbon black content of 1% by weight.

Compound formulation:

| | |
|---|---|
| LDPE | 58.3 g |
| Calcium stearate | 0.2 g |
| Carbon black master batch | 1.5 g |

The resulting compound is extruded through a slit width of 0.3 mm, and the extruded sheet is cut into chips. The chips are molded into a film having a thickness of 65±3 μm on a hot plate set at 240° C.

In multicolor image formation, images of different colors are successively transferred onto the same image receiving sheet by using heat transfer sheets of different colors to form a multicolor image on the image receiving sheet. Alternatively, the image forming layers of heat transfer sheets of different colors are separately transferred to as many image receiving sheets as the heat transfer sheets, and the transfer images are re-transferred onto a sheet of printing paper, etc. to form a multicolor image on the paper.

More specifically, the latter method of forming a multicolor image is carried out, for example, as follows. A laminate of an image receiving sheet and a heat transfer sheet is prepared for each of four or more colors (cyan, magenta, yellow, black, etc.). Each laminate is irradiated with laser light in accordance with the respective digital signals (e.g., through a color separation filter), and the heat transfer sheet is stripped off the image receiving sheet to obtain a color separated image for each color on the image receiving sheet. Thereafter, the color separated images are successively re-transferred to an actual support, such as printing paper or an equivalent, to form a multicolor image.

While the aforementioned laser thermal transfer recording technology is preferably applied to thin film thermal transfer recording, it is also applicable to other thermal transfer systems, such as melt transfer recording, ablation transfer recording, and sublimation transfer recording. Therefore, the system of the invention includes in its scope the image forming elements useful in these other thermal transfer recording systems.

The image forming material according to the present invention, including the heat transfer sheet and the image receiving sheet will be described in detail.

The heat transfer sheet essentially comprises a substrate, a light-heat conversion layer, and an image forming layer and optionally has other layers such as an intermediate layer.

The substrate of the heat transfer sheet can be of any material of choice. It is desirable for the substrate to have stiffness, dimensional stability, and heat resistance withstanding the heat of laser recording. Preferred substrate materials include synthetic resins, such as polyethylene terephthalate, polyethylene-2,6-naphthalate, polycarbonate, polymethyl methacrylate, polyethylene, polypropylene, polyvinyl chloride, polyvinylidene chloride, polystyrene, styrene-acrylonitrile copolymers, polyamide (aromatic or aliphatic), polyimide, polyamide-imide, and polysulfone. A biaxially stretched polyethylene terephthalate film is preferred of them from the standpoint of mechanical strength and dimensional stability against heat. In the preparation of color proofs by laser recording, the substrate of the heat transfer sheet is preferably made of transparent synthetic resins which transmit laser beams. The thickness of the substrate is preferably 25 to 130 μm, still preferably 50 to 120 μm. The substrate preferably has a center-line average surface roughness Ra of less than 0.1 μm on its image forming layer side. In the present invention Ra values are measured in accordance with JIS B0601 with, for example, a profilometer (e.g., Surfcom available from Tokyo Seiki Co., Ltd.). The substrate preferably has a Young's modulus of 200 to 1200 kg/mm2 (≈2 to 12 GPa) in the machine direction (MD) and of 250 to 1600 kg/mm² (≈2.5 to 16 GPa) in the transverse direction (TD). The F-5 value of the substrate in the MD is preferably 5 to 50 kg/mm² (≈49 to 490 MPa), and that in the TD is preferably 3 to 30 kg/mm² (≈29.4 to 294 MPa). The F-5 value in the MD is generally higher than that in the TD, but this is not the case when the substrate is required to be stronger in the TD than in the MD. The thermal shrinkage of the substrate when treated at 100° C. for 30 minutes is preferably 3% or less, still preferably 1.5% or less, in both TD and MD. The thermal shrinkage at 80° C. for 30 minutes is preferably 1% or less, still preferably 0.5% or less, in both MD and TD. The substrate preferably has a breaking strength of 5 to 100 kg/mm² (≈49 to 980 MPa) in both directions and an elastic modulus (20° C.) of 100 to 2,000 kg/mm² (≈0.98 to 19.6 GPa).

In order to improve adhesion between the substrate and the light-heat conversion layer, the substrate may be subjected to a surface activation treatment and/or be provided with one or more undercoating layers. The surface activation treatment includes glow discharge treatment and corona discharge treatment. The materials of the undercoating layer(s) are preferably selected from those having high adhesion to both the substrate and the light-heat conversion layer, low heat conductivity, and high heat resistance. Such materials include polystyrene, a styrene-butadiene copolymer, and gelatin. The total thickness of the undercoating layers is generally 0.01 to 2 μm. If desired, the opposite side of the substrate may also be surface-treated or provided with a functional layer, such as an antireflection layer or an antistatic layer. It is particularly advisable to provide a backcoating layer containing an antistatic agent on the back of the substrate.

The backcoating layer preferably comprises a first backcoating layer contiguous to the substrate and a second backcoating layer provided on the first backcoating layer. It is preferred that the weight ratio of the antistatic agent B contained in the second backcoating layer to the antistatic agent A contained in the first backing layer, B/A, be less than 0.3. A B/A ratio of 0.3 or more tends to result in reduction of sliding properties and cause powder fall-off from the backcoating layer.

The thickness C of the first backcoating layer is preferably 0.01 to 1 μm, still preferably 0.01 to 0.2 μm. The thickness D of the second backcoating layer is preferably 0.01 to 1 μm, still preferably 0.01 to 0.2 μm. The thickness ratio C/D is preferably 1/2 to 5/1.

The antistatic agents which can be used in the first and second backcoating layers include nonionic surface active agents, e.g., polyoxyethylene alkylamines and glycerol fatty acid esters; cationic surface active agents, e.g., quaternary ammonium salts; anionic surface active agents, e.g., alkylphosphates; amphoteric surface active agents; and electrically conductive resins.

Fine electrically conductive particles can also be used as an antistatic agent. Examples of such fine electrically conductive particles include oxides, e.g., ZnO, TiO₂, SnO₃, Al₂O₃, In₂O₃, MgO, BaO, CoO, CuO, Cu₂O, CaO, SrO, BaO₂, PbO, PbO₂, MnO₂, MoO₃, SiO₂, ZrO₂, Ag₂O, Y₂O₃, Bi₂O₃, Ti₂O₃, Sb₂O₃, Sb₂O₅, K₂Ti₆O₁₃, NaCaP₂O₁₈, and MgB₂O₅; sulfides, e.g., CuS and ZnS; carbides, e.g., SiC, TiC, ZrC, VC, NbC, MoC, and WC; nitrides, e.g., Si₃N₄, TiN, ZrN, VN, NbN, and Cr₂N; borides, e.g., TiB₂, ZrB₂, NbB₂, TaB₂, CrB, MoB, WB, and LaB₅; silicides, e.g., TiSi₂, ZrSi₂, NbSi₂, TaSi₂, CrSi₂, MoSi₂, and WSi₂; metal salts, e.g., BaCO₃, CaCO₃, SrCO₃, BaSO₄, and CaSO₄; and composites, e.g., SiN₄/SiC and9Al₂O₃/2B₂O₃. These electrically conductive substances may be used either alone or in a combination of two or more thereof. Preferred of them are SnO₂, ZnO, Al₂O₃, TiO₂, In₂O₃, MgO, BaO, and MoO₃. Still preferred are SnO₂, ZnO, In₂O₃, and TiO₂, with SnO₂ being particularly preferred.

In laser thermal transfer recording, the antistatic agents used in the backcoating layer are preferably substantially transparent so as to transmit laser beams.

In using an electrically conductive metal oxide as the antistatic agent, the particle size is preferably as small as possible to minimize light scattering, but the particle size should be determined based on the ratio of the refractive index of the particles to that of the binder as a parameter, which can be obtained according to Mie theory. The average particle size of the electrically conductive metal oxide is generally 0.001 to0.5 μm, preferably 0.003 to 0.2 μm. The term “average particle size” as used herein is intended to cover not only primary particles but agglomerates.

The first and second backcoating layers may further contain a binder and various other additives, such as surface active agents, slip agents, and matting agents. The amount of the antistatic agent in the first backcoating layer is preferably 10 to 1,000 parts by weight, still preferably 200 to 800 parts by weight, per 100 parts by weight of the binder. The amount of the antistatic agent in the second backcoating layer is preferably 0 to 300 parts by weight, still preferably 0 to 100 parts by weight, per 100 parts by weight of the binder.

The binders which can be used in the first and second backcoating layers include homopolymers and copolymers of acrylicmonomers, e.g., acrylic acid, methacrylic acid, acrylic esters and methacrylic esters; cellulosic polymers, e.g., nitrocellulose, methyl cellulose, ethyl cellulose, and cellulose acetate; polymers of vinyl compounds, e.g., polyethylene, polypropylene, polystyrene, vinyl chloride copolymers, vinyl chloride-vinyl acetate copolymers, polyvinyl pyrrolidone, polyvinyl butyral, and polyvinyl alcohol; condensed polymers, e.g., polyester, polyurethane, and polyamide; elastic thermoplastic polymers, e.g., butadiene-styrene copolymers; polymers obtained by polymerization or crosslinking of photopolymerizable or heat polymerizable compounds, e.g., epoxy compounds; and melamine compounds.

The light-heat conversion layer comprises a light-heat converting substance and a binder. If necessary, it can contain a matting agent. It may further contain other additives, if desired.

The light-heat converting substance is a substance capable of converting light energy to heat energy when irradiated with light. This substance is generally a colorant (inclusive of a dye and a pigment) capable of absorbing laser light. In infrared laser recording, infrared absorbing colorants are preferably used. Useful infrared absorbing colorants include black pigments, e.g., carbon black; macrocyclic compound pigments showing absorption in the visible to near-infrared region, such as phthalocyanine pigments and naphthalocyanine pigments; organic dyes used in high-density laser recording media (e.g., optical disks), such as cyanine dyes (e.g., indolenine dyes), anthraquinone dyes, azulene dyes, and phthalocyanine dyes; and organometallic colorants, such as dithiol nickel complexes. Inter alia, cyanine dyes have a high absorptivity coefficient in the infrared region. Use of the cyanine dyes as a light-heat converting substance makes it feasible to reduce the thickness of the light-heat conversion layer, which leads to improved recording sensitivity of the heat transfer sheet. Useful light-heat converting substances include not only the colorants but inorganic materials such as particulate metallic materials, e.g., blackened silver.

The binder which can be used in the light-heat conversion layer is preferably a resin having strength enough to form a layer on the substrate and a high heat conductivity, still preferably a resin having such heat resistance so as not to decompose by the heat generated by the light-heat converting substance. A heat-resistant resin maintains the surface smoothness of the light-heat conversion layer after irradiation with high energy light. Specifically, the binder resin preferably has a decomposition temperature at 50% weight loss (Td₅₀) of 370° C. or higher in thermo gravimetric analysis (TGA) at a rate of temperature rise of 10° C./min in an air stream. The binder resin still preferably has a decomposition temperature at 5% weight loss (Td₅) of 400° C. or higher, particularly 500° C. or higher, in TGA under the same conditions. The binder resin preferably has a glass transition temperature (Tg) of 200° to 400° C., particularly 250° to 350° C. Resins having a Tg lower than 200° C. can cause fogging. Resins having a Tg higher than 400° C. have reduced solubility in a solvent, which can result in reduction of productivity.

It is preferred for the binder of the light-heat conversion layer to have higher heat resistance (e.g., heat deformation temperature and heat decomposition temperature) than the materials used in other layers provided on the light-heat conversion layer.

Useful binder resins for the light-heat conversion layer include acrylic resins, e.g., polymethyl methacrylate; polycarbonate; vinyl resins, e.g., polystyrene, vinyl chloride-vinyl acetate copolymers, and polyvinyl alcohol; polyvinyl butyral, polyester, polyvinyl chloride, polyamide, polyimide, polyamide-imide, polyether imide, polysulfone, polyether sulfone, aramid, polyurethane, epoxy resins, and urea-melamine resins. These binder resins can be used individually or as a combination thereof. Polyamide-imide resins and polyimide resins are especially preferred of them.

Particularly preferred polyamide-imide resins are represented by formula (A):

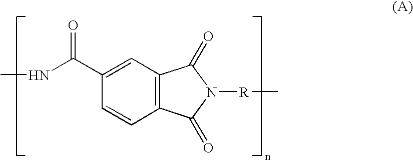

wherein R represents a divalent linking group.

Examples of suitable linking groups R are shown below.

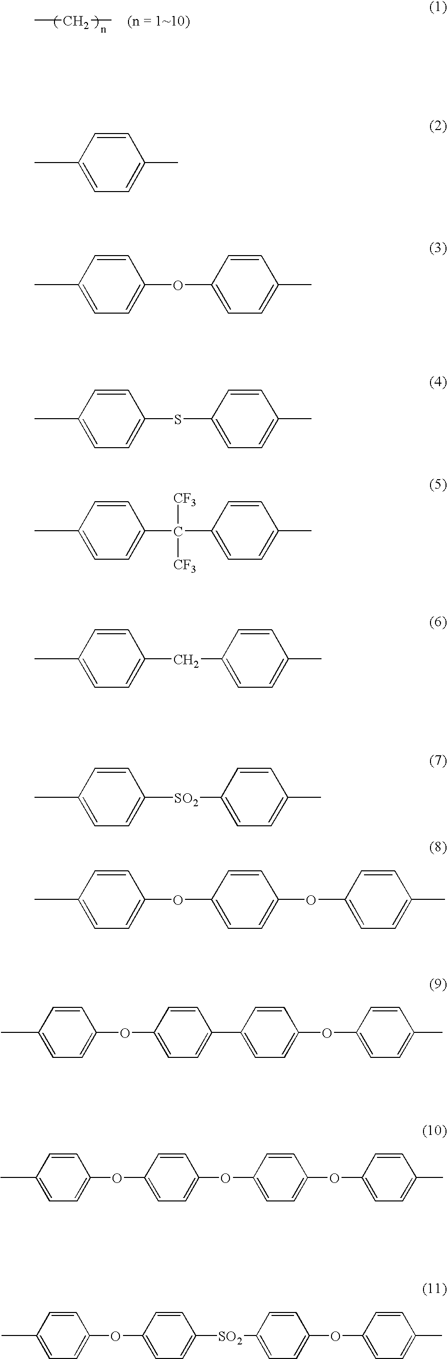

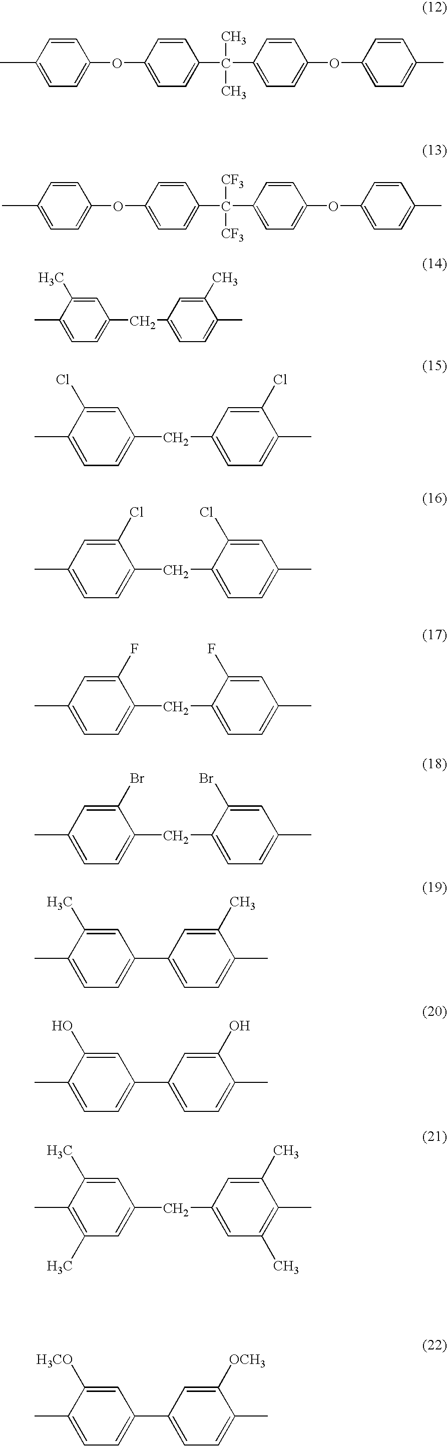

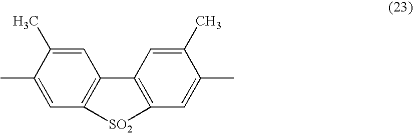

Preferred of these linking groups are (6), (7), (11), and (14). Combinations of the linking groups illustrated above are also useful.

The above-described polyamide-imide resins preferably have a polystyrene equivalent weight average molecular weight of 3,000 to 50,000, particularly 10,000 to 25,000, measured by gel-permeation chromatography.

Particularly preferred polyimide resins-are represented by formulae (I) to (VII) shown below.

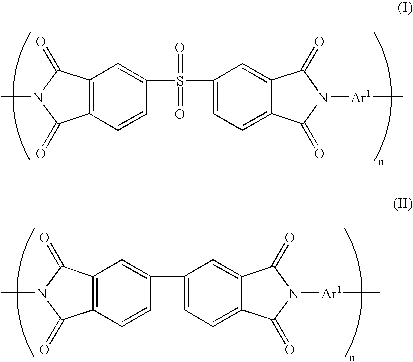

In formulae (I) and (II), Ar¹ represents an aromatic group represented by structural formulae (1) to (3); and n represents an integer of 10 to 100.

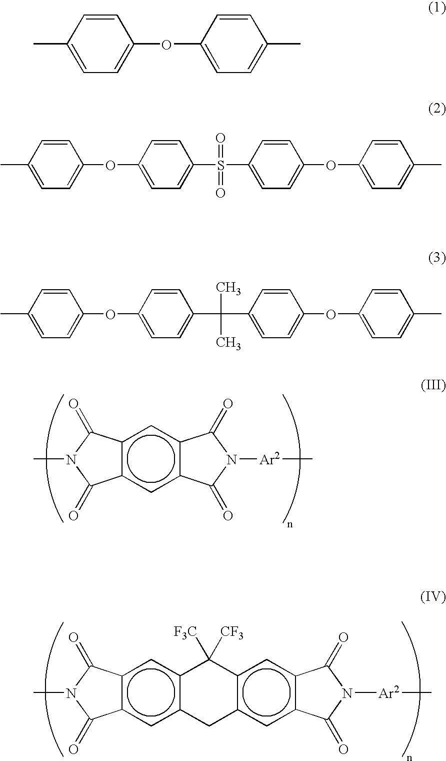

In formulae (III) and (IV), Ar² represents an aromatic group represented by structural formulae (4) to (7); and n represents an integer of 10 to 100.

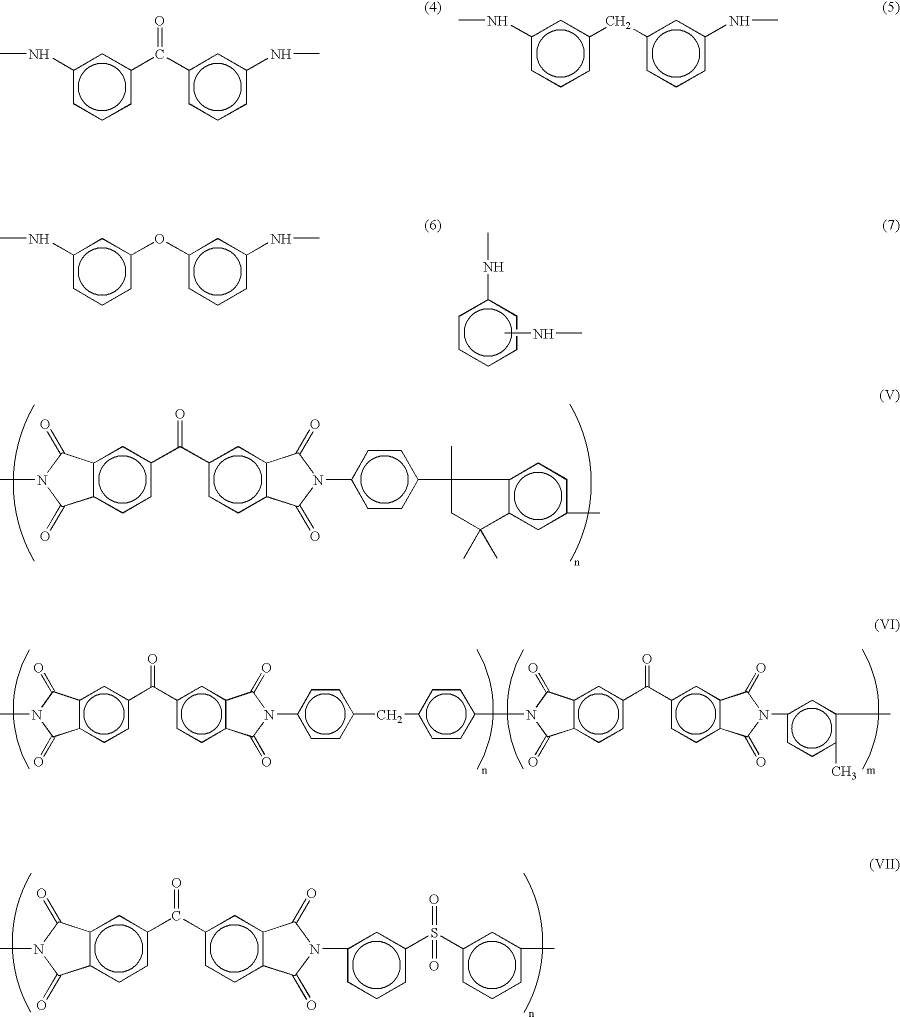

In formulae (V) to (VII), n and m each represent an integer of 10 to 100. In formula (VI), the ratio n/m is 6/4 to 9/1.

It is preferred for the binder of the light-heat conversion layer to be soluble in an organic solvent. A binder having a solubility of at least 10 parts by weight per 100 parts by weight of N-methylpyrrolidone at 25° C. is deemed organic solvent soluble. A binder having a solubility of 100 parts by weight or more per 100 parts by weight of N-methylpyrrolidone is still preferred.

It is preferred for the binder resin, such as polyamide-imide, used in the light-heat conversion layer to have an Sp (solubility parameter) of 25 or greater as calculated according to Okitsu method (see Journal of the Adhesion Society of Japan, Vol. 29, No. 5, 1993). By using a binder resin having an Sp of 25 or greater, migration of the light-heat converting substance, such as the infrared absorbing colorant, or its decomposition products into the image forming layer is reduced to provide a transfer image with a satisfactory and stable hue.

Of the above-described light-heat converting substances particularly preferred are cyanine dyes having a sulfonic acid group represented by formula (B) shown below in view of their high heat resistance and stability against decomposition with time in a coating composition, i.e., stability against reduction in absorbance. The compounds of formula (B) are especially effective when combined with the polyamide-imide resins as previously stated.

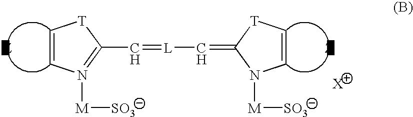

wherein Z represents an atomic group necessary to form a benzene ring, a naphthalene ring, a pyridine ring, a quinoline ring, a pyrazine ring, a quinoxaline ring, etc.; T represents —O—, —S—, —Se—, —N(R¹)—, —C(R²) (R³)— or —C(R⁴)═C(R⁵)—; R¹, R², R³, R⁴, and R⁵ each preferably represent a substituted or unsubstituted alkyl group, a substituted or unsubstituted aryl group or a substituted or unsubstituted alkenyl group; L represents a trivalent linking group made of conjugated 5 or 7 methine groups; M represents a divalent linking group; and X⁺ represents a cation.

The atomic group Z may have one or more substituents R⁶. The substituents R⁶ include an alkyl group, an aryl group, a heterocyclic group, a halogen atom, an alkoxy group, an aryloxy group, an alkylthio group, an arylthio group, an alkylcarbonyl group, an arylcarbonyl group, an alkyloxycarbonyl group, an aryloxycarbonyl group, an alkylcarbonyloxy group, an arylcarbonyloxy group, an alkylamido group, an arylamido group, an alkylcarbamoyl group, an arylcarbamoyl group, an alkylamino group, an arylamino group, a carboxyl group, an alkylsulfonyl group, an arylsulfnyl group, an alkylsulfonamido group, an arylsulfonamido group, an alkylsulfamoyl group, an arylsulfamoyl group, a cyano group, and a nitro group. The number of the substituents R⁶ that are possessed by Z is usually up to about 4. Where there are two or more substituents R⁶, they may be the same or different.

Preferred substituents R⁶ include a halogen atom (e.g., F or Cl), a cyano group, a substituted or unsubstituted alkoxy group having 1 to 20 carbon atoms (e.g., methoxy, ethoxy, dodecyloxy or methoxyethoxy), a substituted or unsubstituted phenoxy group having 6 to 20 carbon atoms (e.g., phenoxy, 3,5-dichlorophenoxyor2,4-di-t-pentylphenoxy), a substituted or unsubstituted alkyl group having 1 to 20 carbon atoms (e.g., methyl, ethyl, isobutyl, t-pentyl, octadecyl or cyclohexyl), and a substituted or unsubstituted phenyl group having 6 to 20 carbon atoms (e.g., phenyl, 4-methylphenyl, 4-trifluoromethylphenyl or 3,5-dichlorophenyl).

In T representing —O—, —S—, —Se—, —N(R¹)—, —C(R²) (R³)— or —C(R⁴)═C(R⁵)—, R¹, R², R³, R⁴, and R⁵ each still preferably represent an alkyl group. The group represented by R¹, R², R³, R⁴ or R⁵ preferably contains 1 to 30 carbon atoms, particularly 1 to 20 carbon atoms.

Substituents the groups R¹, R², R³, R⁴, and R⁵ may have preferably include a sulfonic acid group, an alkylcarbonyloxy group, an alkylamido group, an alkylsulfonamido group, an alkoxycarbonyl group, an alkylamino group, an alkylcarbamoyl group, an alkylsulfamoyl group, an alkoxy group, an aryloxy group, an alkylthio group, an arylthio group, an alkyl group, an aryl group, a carboxyl group, a halogen atom, and a cyano group.

Still preferred among these substituents are a halogen atom (e.g., F or Cl), a cyano group, a substituted or unsubstituted alkoxy group having 1 to 20 carbon atoms (e.g., methoxy, ethoxy, dodecyloxy or methoxyethoxy), a substituted or unsubstituted phenoxy group having 6 to 20 carbon atoms (e.g., phenoxy, 3,5-di-chlorophenoxy or 2,4-di-t-pentylphenoxy), a substituted or unsubstituted alkyl group having 1 to 20 carbon atoms (e.g., methyl, ethyl, isobutyl, t-pentyl, octadecyl or cyclohexyl), and a substituted or unsubstituted phenyl group having 6 to 20 carbon atoms (e.g., phenyl, 4-methylphenyl, 4-trifluoromethylphenyl or 3,5-dichlorophenyl). R¹, R², R³, R⁴, and R⁵ each particularly preferably represent an unsubstituted alkyl group having 1 to 8 carbon atoms. T is most preferably —C (CH₃)₂—.

L represents a trivalent linking group made of 5 or 7 conjugated methine groups (i.e., a pentamethine group or a heptamethine group), which maybe substituted or unsubstituted. Preferred linking groups L are shown below.

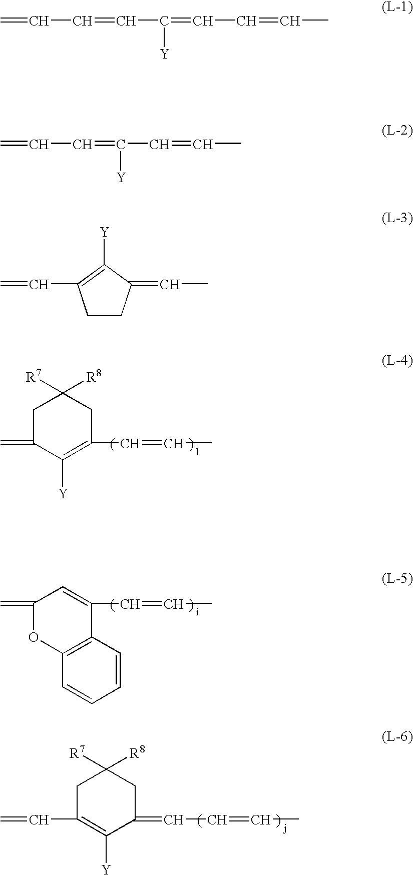

wherein Y represents a hydrogen atom or a substituent; and R⁷ and R⁸ each represent a hydrogen atom or a substituent; i represents 1 or 2; and j represents 0 or 1.

Particularly preferred linking groups are those providing tricarbocyanine dyes, i.e., (L-2), (L-3), (L-4), (L-5), and (L-6). In the linking groups (L-1) to (L-6) illustrated above, suitable substituents as represented by Y include a lower alkyl group (e.g., methyl), a lower alkoxy group (e.g., methoxy), a substituted amino group (e.g., dimethylamino, diphenylamino, methylphenylamino, morpholino, imidazolidinyl or ethoxycarbonylpiperazinyl), an alkylcarbonyloxy group (e.g., acetoxy), an alkylthio group (e.g., methylthio), a cyano group, a nitro group, and a halogen atom (e.g., Br, Cl or F).

Y is preferably a hydrogen atom. R⁷ and R⁸ each preferably represent a hydrogen atom or a lower alkyl group having 1 to 5 carbon atoms (e.g., methyl).

The divalent linking group represented by M is preferably a substituted or unsubstituted alkylene group having 1 to 20 carbon atoms, e.g., ethylene, propylene or butylene.

The cation as represented by X⁺ includes a metal ion (e.g., Na⁺ or K⁺), an ammonium ion (e.g., HN⁺(C₂H₅)₃), and a pyridinium ion.

Specific examples of the compounds represented by formula (B) are shown below for illustrative purposes only but not for limitation.

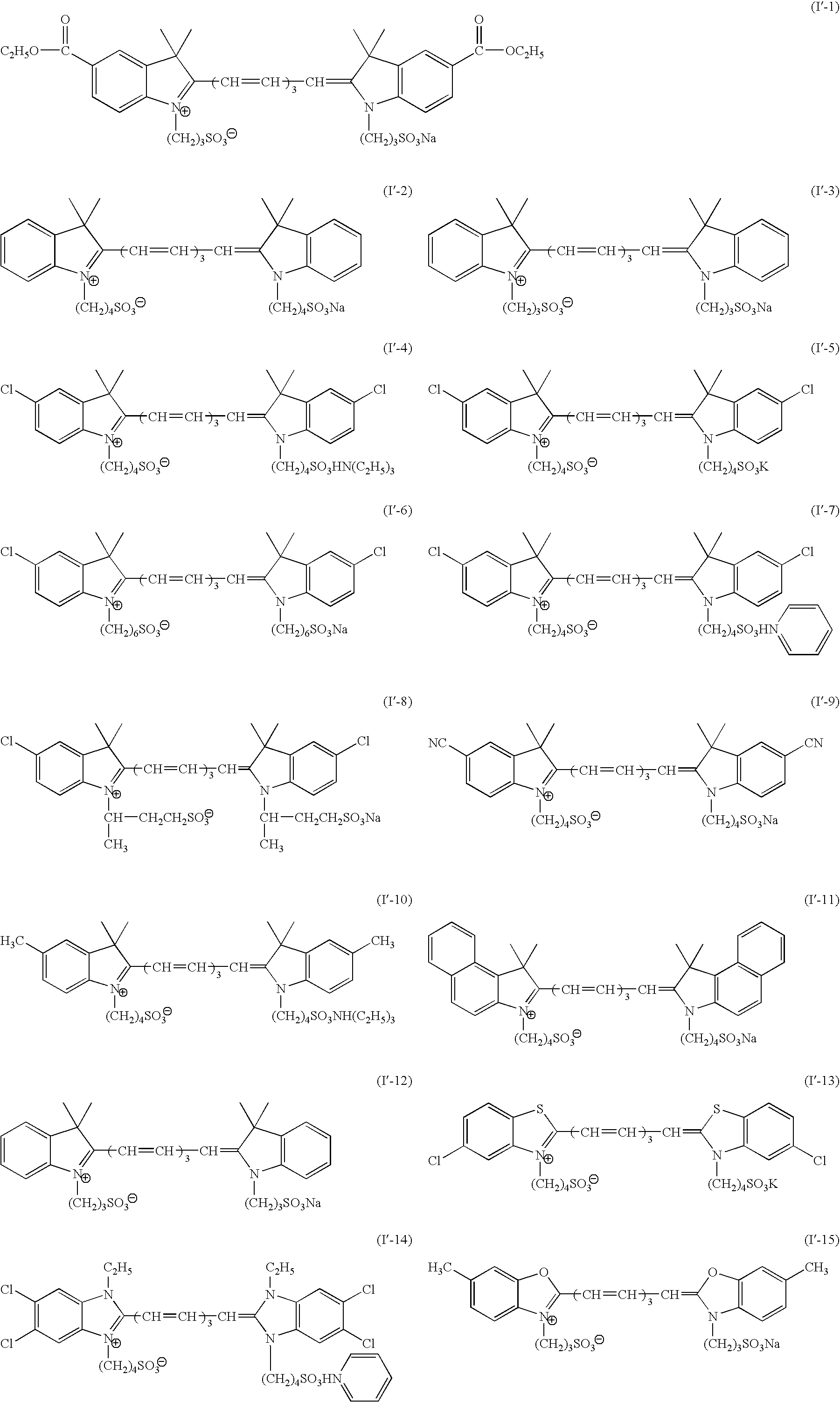

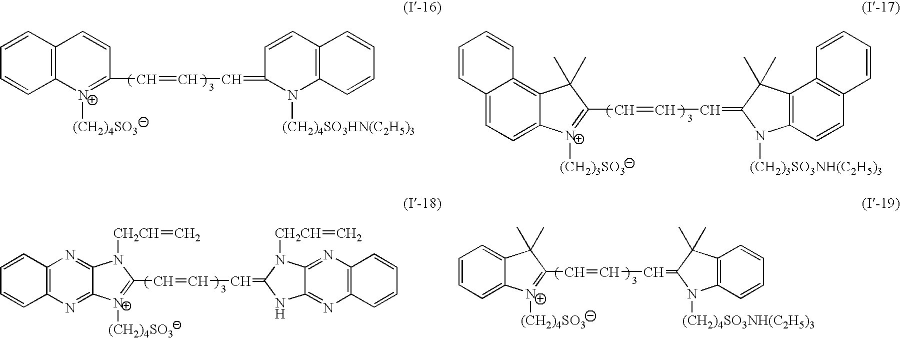

The compounds of formula (B) are generally synthesized with ease in the same manner as for other carbocyanine dyes by reacting a heterocyclic enamine with an acetal (e.g., CH₃O—CH═CH—CH═CH—CH(OCH₃)₂), a compound represented by PhN—CH—(CH—CH)—NHPh (where Ph represents phenyl), etc. For the detail, JP-A-5-116450 can be referred to.

It is preferred that the light-heat converting substance has a decomposition temperature of 200° C. or higher, particularly 250° C. or higher. A high decomposition temperature eliminates fogging caused by coloring with decomposition products. Light-heat converting substances whose decomposition temperature is lower than 200° C. can decompose, and the resultant decomposition products can cause coloring (fogging) to reduce the image quality.

While it is desirable that the light-heat conversion layer contain the compound of formula (B) as a main light-heat converting substance, known light-heat converting substances may be used in combination in an amount that does not impair the advantages of the compound of formula (B). The known light-heat converting substances are generally colorants (inclusive of dyes and pigments) capable of absorbing laser light. Such colorants include black pigments, e.g., carbon black; macrocyclic compound pigments showing absorption in the visible to near-infrared region, such as phthalocyanine pigments and naphthalocyanine pigments; organic dyes used in high-density laser recording media (e.g., optical disks), such as cyanine dyes other than the indolenine dyes of formula (B), anthraquinone dyes, azulene dyes, and phthalocyanine dyes; and organometallic colorants, such as dithiol nickel complexes.

The matting agents which can be added to the light-heat conversion layer include fine inorganic or organic particles. The fine inorganicparticles include metal oxides, e.g., silica, titaniumoxide, aluminumroxide, zincoxide, andmagnesiumoxide, metal salts, e.g., barium sulfate, magnesium sulfate, aluminum hydroxide, magnesium hydroxide, and boron nitride, kaolin, clay, talc, zinc flower, lead white, zeeklite, quartz, diatomaceous earth, pearlite, bentonite, mica, andsyntheticmica. The fine organic particles include particles of fluorine resins, guanamine resins, acrylic resins, styrene-acrylic copolymer resins, silicone resins, melamine resins, and epoxy resins.

The matting agent usually has a particle size of 0.3 to 30 μm, preferably 0.5 to 20 μm. It is preferably added in an amount of 0.1 to 100 mg/m².

If desired, the light-heat conversion layer can contain surface active agents, thickeners, antistatic agents, and the like.

The light-heat conversion layer is formed by applying a coating composition to a substrate and drying the coating. The coating composition is preparedbydissolving the light-heat converting substance and a binder in an organic solvent and adding thereto a matting agent and other necessary additives. Organic solvents which can be used to dissolve the binder include n-hexane, cyclohexane, diglyme, xylene, toluene, ethyl acetate, tetrahydrofuran, methyl ethyl ketone, acetone, cyclohexanone, 1,4-dioxane, 1,3-dioxane, dimethyl acetate, N-methyl-2-pyrrolidone, dimethyl sulfoxide, dimethylformamide, dimethylacetamide, γ-butyrolactone, ethanol, and methanol. Application and drying of the coating composition can be carried out in a conventional manner. Drying is usually effected at temperatures of 300° C. or lower, preferably 200° C. or lower. Where a polyethylene terephthalate substrate is used, drying is preferably performed at 80 to 150° C.

Where the amount of the binder in the light-heat conversion layer is too small, the light-heat conversion layer has reduced cohesion and tends to accompany the image forming layer being transferred to the image receiving sheet, which causes image color mixing. Use of too much amount of the binder necessitates an increase in layer thickness for achieving a given absorbance, which can invite sensitivity reduction. The solid basis weight ratio of the light-heat converting substance to the binder in the light-heat conversion layer is preferably 1:20 to 2:1, still preferably 1:10 to 2:1.

As the light-heat conversion layer is made thinner, the sensitivity increases as stated previously. The thickness of the light-heat conversion layer is preferably 0.03 to 1.0 μm, still preferably 0.05 to 0.5 μm. From the standpoint of transfer sensitivity, the optical density of the light-heat conversion layer is preferably 0.80 to 1.26, still preferably 0.92 to 1.15, at a wavelength of 808 nm. If the optical density at a laser peak wavelength is less than 0.80, light to heat conversion tends to be insufficient, resulting in reduced transfer sensitivity. An optical density exceeding 1.26 will adversely affect the recording function of the light-heat conversion layer, which can result in fogging.

The image forming layer of the heat transfer sheet contains a pigment which is transferred to the image receiving sheet to form an image, a binder for forming the layer, and, if desired, other components.

The pigment that can be used in the image forming layer are roughly divided into organic ones and inorganic ones. Organic pigments are particularly excellent in film transparency, and inorganic ones are generally excellent in hiding powder. Proper pigments are selected according to the purpose with these characteristics taken into consideration. In making heat transfer sheets for color proofing, it is preferred to use organic pigments whose color tones match or approximate the colors of printing inks, such as yellow (Y), magenta (M), cyan (C), and black (K). Metallic powders, fluorescent pigments, and the like are also used in some cases. Suitable organic pigments include azo pigments, phthalocyanine pigments, anthraquinone pigments, dioxazine pigments, quinacridone pigments, isoindolinone pigments, and nitro pigments. The pigments useful in the image forming layer are listed below for illustrative purposes only but not for limitation.

1) Yellow pigment

Pigment Yellow 12 (C.I. No. 21090):

Example: Permanent Yellow DHG (from Clariant (Japan) KK), Lionol Yellow 1212B (from Toyo Ink Mfg. Co., Ltd.), Irgalite Yellow LCT (from Ciba Specialty Chemicals), Symuler Fast Yellow GTF219 (from Dainippon Ink & Chemicals, Inc.)

Pigment Yellow 13 (C.I. No. 21100):

Example: Permanent Yellow GR (from Clariant (Japan) KK), Lionol Yellow 1313 (from Toyo Ink Mfg. Co., Ltd.)

Pigment Yellow 14 (C.I. No. 21095):

Example: Permanent Yellow G (from Clariant (Japan) KK), Lionol Yellow 1401-G (from Toyo Ink Mfg. Co., Ltd.), Seika Fast Yellow 2270 (from Dainichiseika Colour & Chemicals Mgf. Co., Ltd.), Symuler Fast Yellow 4400 (from Dainippon Ink & Chemicals, Inc.)

Pigment Yellow 17 (C.I. No. 21105):

Example: Permanent Yellow GG02 (from Clariant (Japan) KK), Symuler Fast Yellow 8GF (from Dainippon Ink & Chemicals, Inc.)

Pigment Yellow 155:

Example: Graphtol Yellow 3GP (from Clariant (Japan) KK)

Pigment Yellow 180 (C.I. No. 21290):

Example: Novoperm Yellow P-HG (from Clariant (Japan) KK.), PV Fast Yellow HG (from Clariant (Japan) KK.)

Pigment Yellow 139 (C.I. No. 56298):

Example: Novoperm Yellow M2R 70 (from Clariant (Japan) KK.)

2) Magenta Pigment

Pigment Red 57:1 (C.I. No. 15850:1):

Example: Graphtol Rubine L6B (from Clariant (Japan) KK), Lionol Red 6B-4290G (from Toyo Ink Mfg. Co., Ltd.), Irgalite Rubine 4BL (from Ciba Specialty Chemicals), Symuler Brilliant Carmine 6B-229 (from Dainippon Ink & Chemicals, Inc.)

Pigment Red 122 (C.I. No. 73915):

Example: Hosterperm Pink E (from Clariant (Japan) KK.), Lionogen Magenta 5790 (from Toyo Ink Mfg. Co., Ltd.), Fastogen Super Magenta RH (from Dainippon Ink & Chemicals, Inc.)

Pigment Red 53:1 (C.I. No. 15585:1):

Example: Permanent Lake Red LCY (from Clariant (Japan) KK), Symuler Lake Red C conc (from Dainippon Ink & Chemicals, Inc.)

Pigment Red 48:2 (C.I. No. 15865:2):

Example: Permanent Red W2T (from Clariant (Japan) KK), Lionol Red LX235 (from Toyo Ink Mfg. Co., Ltd.), Symuler Red 3012 (from Dainippon Ink & Chemicals, Inc.)

Pigment Red 177 (C.I. No. 65300):

Example: Cromophtal Red A2B (from Ciba Specialty Chemicals)

3) Cyan Pigment

Pigment Blue 15 (C.I. No. 74160):

Example: Lionol Blue 7027 (from Toyo Ink Mfg. Co., Ltd.), Fastogen Blue BB (from Dainippon Ink & Chemicals, Inc.)

Pigment Blue 15:1 (C.I. No. 74160):

Example: Hosterperm Blue A2R (from Clariant (Japan) KK), Fastogen Blue 5050 (from Dainippon Ink & Chemicals, Inc.)

Pigment Blue 15:2 (C.I. No. 74160):

Example: Hosterperm Blue AFL (from Clariant (Japan) KK), Irgalite Blue BSP (from Ciba Specialty Chemicals), Fastogen Blue GP (from Dainippon Ink & Chemicals, Inc.)

Pigment Blue 15:3 (C.I. No. 74160):

Example: Hosterperm Blue B2G (from Clariant (Japan) KK.), Lionol Blue FG7330 (from Toyo Ink Mfg. Co., Ltd.), Cromophtal Blue 4GNP (from Ciba Specialty Chemicals), Fastogen Blue FGF (from Dainippon Ink & Chemicals, Inc.)

Pigment Blue 15:4 (C.I. No. 74160):

Example: Hosterperm Blue BFL (from Clariant (Japan) KK), Cyanine Blue 700-10 FG (from Toyo Ink Mfg. Co., Ltd.), Irgalite Blue GLNF (from Ciba Specialty Chemicals), Fastogen Blue FGS (from Dainippon Ink & Chemicals, Inc.)

4) Black Pigment

Pigment Black 7 (carbon black C.I. No. 77266):

Example: Mitsubishi Carbon Black MA100 (from Mitsubishi Chemicals Co., Ltd.), Mitsubishi Carbon Black #5 (from Mitsubishi Chemicals Co., Ltd.), Black Pearls 430 (from Cabot Co.)

The pigments to be used in the invention can be chosen from commercially available products by referring to Nippon Ganryo Gijutsu Kyokai (ed.), Ganryo Binran, Seibundo Shinko-Sha (1989), and COLOUR INDEX, THE SOCIETY OF DYES & COLOURIST, 3rd Ed. (1987).

The above-described pigments preferably have an average particle size of 0.03 to 1 μm, particularly 0.05 to 0.5 μm. Where the average particle size is smaller than 0.03 μm, pigment dispersing cost tends to increase, and the dispersion tends to gel. As far as the average particle size is 1 μm or smaller, there is no coarse particles, which assures good adhesion between the image forming layer and the image receiving layer and improves the transparency of the image forming layer.

The binder to be used in the image forming layer comprises at least one of the above-specified acrylic resin and styrene-acrylic copolymer resin both having a Tg of 50° C. or lower and an MFT of 50° C. or lower.

The image forming layer can further contain surface active agents, organic or inorganic particles (e.g., metal powder and silica gel), oils (e.g., linseed oil and mineral oil), thickeners, antistatic agents, and so forth. A substance having an absorption at a writing laser wavelength can be added to the image forming layer except for the case where a black image is to be formed, which is beneficial for transfer energy saving. While such a substance may be either a pigment or a dye, it is desirable for color reproduction to use an infrared light source (e.g., semiconductor laser) for writing and to add a dye having a small absorption in the visible region and a large absorption at the wavelength of the light source. Useful near infrared absorbing dyes are described in JP-A-3-103476.

An intermediate layer can be provided on the light-heat conversion layer. The intermediate layer includes a heat-sensitive release layer containing a heat-sensitive material which generates gas or releases adsorption water by the action of the heat generated by the light-heat conversion layer and thereby reduces the adhesive strength between the light-heat conversion layer and the image forming layer. Such a heat-sensitive material includes those compounds, inclusive of polymers and low-molecular compounds, which decompose or denature by heat to generate gas, and those compounds, inclusive of polymers and low-molecular compounds, which have absorbed or adsorbed a considerable amount of a volatile compound, such as water. These types of compounds may be used in combination.

Polymers which generate gas on thermal decomposition or denaturation include self-oxidizing polymers, e.g., nitrocellulose; halogen-containing polymers, e.g., chlorinated polyolefin, chlorinated rubber, polychlorinated rubber, polyvinyl chloride, and polyvinylidene chloride; acrylic polymers (e.g., polyisobutyl methacrylate) having adsorbed a volatile compound such as water; cellulose esters (e.g., ethyl cellulose) having adsorbed a volatile compound such as water; and natural high molecular compounds (e.g., gelatin) having adsorbed a volatile compound such as water. Low-molecular compounds which generate gas on heat decomposition or denaturation include those which thermally decompose to generate gas, such as diazo compounds and azide compounds.

It is desirable that decomposition or denaturation of the heat-sensitive material should occur at 280° C. or lower, particularly 230° C. or lower.

When a low-molecular heat-sensitive material is used in the heat-sensitive release layer, it is preferably used in combination with a binder. The binder to be used may be either of the type that decomposes or denatures to generate gas or of the type that does not. The weight ratio of the low-molecular heat-sensitive material to the binder if used is preferably 0.02/1 to 3/1, still preferably 0.05/1 to 2/1. It is preferred that the heat-sensitive release layer be provided on substantially the entire surface of the light-heat conversion layer. The thickness of the heat-sensitive release layer is usually 0.03 to 1 μm, preferably 0.05 to 0.5 μm.

It is preferred to provide a single or multi-layered trapping layer as an intermediate layer on the light-heat conversion layer. A trapping layer traps decomposition products of an infrared absorbing dye produced by the heat of laser recording thereby to prevent or control migration of the decomposition products into the image forming layer. To perform the function, it is preferred for the trapping layer to be compatible with the infrared absorbing dye decomposition products and the light-heat conversion layer. The binder of the trapping layer preferably includes mordant resins, water soluble resins, and resins having an Sp value of 23 or more.

The mordant resins are preferably mordant polymers having a carboxyl group, a sulfo group or a quaternary ammonium salt group in the side chain thereof. The water-soluble resins preferably include polyvinylpyrrolidone, polyvinyl alcohol, gelatin species, water-soluble nylon, cellulosic resins, and modified cellulosic resins. These resins can be used individually or as a combination thereof.

In order for the trapping layer to perform its trapping function without impairing recording sensitivity, the total thickness of the trapping layer is preferably 0.03 to 0.5 μm, still preferably 0.03 to 0.1 μm.

It is preferred for the heat transfer sheet to have a coefficient of static friction of 0.35 or smaller, particularly 0.20 or smaller, on its surface of the image forming layer side. With this surface condition, the feed rollers for carrying the heat transfer sheets are prevented from being contaminated, and the quality of the transfer image can be improved. The coefficient of static friction is measured in accordance with the method taught in JP-A-2001-47753, par. [0011].

The surface of the image forming layer preferably has a smooster value of 0.5 to 50 mmHg (≈0.0665 to 6.65 kPa) at 23° C. and 55% RH and a center-line average surface roughness Ra of 0.05 to 0.4 aim. The Ra is measured with a profilometer, e.g., Surfcom (available from Tokyo Seimitsu Co., Ltd.) in accordance with JIS B0601. With these surface roughness parameters falling within the respective ranges, the microscopic spaces formed between the image receiving layer and the image forming layer are reduced in size and number, which favors to image transfer and image quality. The surface hardness of the image forming layer is preferably 10 g or more measured with a sapphire stylus. The static dissipation capability of the image forming layer is preferably such that, when a heat transfer sheet is electrically charged and then grounded according to Federal Test Standard Method 4046, the electrification potential 1 second after grounding is −100 to 100 V. It is preferred that the surface resistivity of the image forming layer at 23° C. and 55% RH be 10⁹ Ω or less.

The image receiving sheet which can be used in combination with the transfer sheet of the present invention generally comprises a substrate and at least one image receiving layer. The image receiving sheet may additionally have one or more layers selected from a cushioning layer, a release layer, and an intermediate layer provided between the substrate and the image receiving layer. To secure smooth pass of the image receiving sheet in the recording apparatus, it is preferred to provide a backcoating layer on the back side of the substrate.

The substrate of the image receiving sheet includes a resin sheet, a metal sheet, a glass sheet, resin-coated paper, paper, and various composite laminates. Resins which can be used as a substrate include polyethylene terephthalate, polycarbonate, polyethylene, polyvinyl chloride, polyvinylidene chloride, polystyrene, styrene-acrylonitrile copolymers, and polyester. Paper as a substrate includes actual printing paper and coated paper.

It is preferred for the substrate to have micro voids to improve quality of a transfer image. Substrates with micro voids can be obtained by, for example, extruding one or more molten mixtures of a thermoplastic resin and a filler, such as an inorganic pigment or a polymer incompatible with the thermoplastic resin matrix, into a single-layer or multilayer film and stretching the extruded film uniaxially or biaxially. The void of the resulting stretched film depends on the kinds of the resin and the filler, the mixing ratio, and the stretching conditions.

As a thermoplastic resin matrix, a polyolefin resin, such as polypropylene, or polyethylene terephthalate is preferably used in view of their good crystallinity and stretchability necessary to form voids. A combination of a polyolefin resin or polyethylene terephthalate and a minor proportion of other thermoplastic resin is preferred. The inorganic pigment used as a filler preferably has an average particle size of from 1 to 20 μm. Useful pigments are calcium carbonate, clay, diatomaceous earth, titanium oxide, aluminum hydroxide, and silica. In using polypropylene as a thermoplastic resin matrix, polyethylene terephthalate is a preferred filler incompatible with the matrix. For the details of preparation of a substrate with micro voids, reference can be made in JP-A-2001-105752. The content of the filler, such as an inorganic pigment, in the substrate is usually about 2 to 30% by volume.

The thickness of the substrate of the image receiving sheet is usually from 10 to 400 μm, preferably 25 to 200 μm. The substrate may be subjected to surface treatment, e.g., corona discharge treatment or glow discharge treatment to have improved adhesion to the image receiving layer (or a cushioning layer if provided as described infra) or to improve the adhesion between the image receiving layer and the image forming layer of the heat transfer sheet.

The image receiving sheet has at least one image receiving layer for receiving and holding the image forming layer being transferred from the heat transfer sheet. The image receiving layer is preferably formed of a resin binder matrix. The resin binder is preferably a thermoplastic resin. Examples of suitable thermoplastic resin binders include homopolymers and copolymers of acrylicmonomers, e.g., acrylic acid, methacrylic acid, acrylicesters, and methacrylicesters; cellulosic resins, e.g. ,methyl cellulose, ethyl cellulose, and cellulose acetate; homopolymers and copolymers of vinyl monomers, e.g., polystyrene, polyvinylpyrrolidone, polyvinyl butyral, polyvinyl alcohol, and polyvinyl chloride; condensed polymers, e.g., polyester and polyamide; and rubbery polymers, e.g., butadiene-styrene copolymers. The binder of the image receiving layer preferably has a Tg of 90° C. or lower so as to exhibit moderate adhesion to the image forming layer. A plasticizer may be added to the image receiving layer for the purpose of lowering the Tg. The binder resin preferably has a Tg of 30° C. or higher for preventing film blocking. It is particularly preferred that the binder resin of the image receiving layer of the image receiving sheet and that of the image forming layer of the heat transfer sheet be the same or at least analogous to each other so that these layers may be in intimate contact during laser writing thereby to improve transfer sensitivity and image strength.

The surface of the image receiving layer preferably has a smooster value of 0.5 to 50 mmHg (≈0.0665 to6.65 kPa) measured at 23° C. and 55% RH and an Ra of 0.5 to 0.4 μm. The Ra is measured with a profilometer (Surfcom available from Tokyo Seimitsu Co., Ltd.) in accordance with JIS B0601. The surface roughness parameters of the image receiving layer falling within these ranges, the microscopic spaces formed between the image receiving layer and the image forming layer are reduced in size and number, which favors to image transfer and image quality. The static dissipation capability of the image receiving layer is preferably −100 to 100 V as measured in the same manner as described above. It is preferred that the surface resistivity of the image receiving layer at 23° C. and 55% RH be 10⁹ Ω or less. The image receiving layer preferably has a coefficient of static friction of 0.2 or smaller and a surface energy of 23 to 35 mg/m².

Where the transfer image on the image receiving layer is re-transferred to printing paper, etc., it is preferred that at least one image receiving layer be made of a photocuring material. A photocuring material includes a combination comprising (a) at least one photo polymerizable monomer selected from polyfunctional vinyl and/or vinylidene compounds capable of addition polymerization, (b) an organic polymer, and (c) a photopolymerization initiator, and optionally (d) additives such as a thermal polymerization inhibitor. The polyfunctional vinyl monomers (a) include unsaturated esters of polyols, particularly acrylic or methacrylic esters (e.g., ethylene glycol diacrylate and pentaerythritol tetraacrylate).

The organic polymer (b) includes those recited above for use to form the image receiving layer. The photo polymerization initiator (c) includes ordinary photo-radical polymerization initiators, e.g., benzophenone and Michler's ketone. The initiator is usually used in an amount of 0.1 to 20% by weight based on the weight of the layer.

The thickness of the image receiving layer is generally from 0.3 to 7 μm, preferably from 0.7 to 4 μm. A thickness of 0.3 μm or larger secures sufficient film strength in re-transferring to printing paper. With a thickness of 4 μm or smaller, glossiness of the image after re-transfer to printing paper is suppressed to provide a better approximation to final prints.

A cushioning layer that is easily deformable with external stresses imposed on the image receiving layer may be provided between the substrate and the image receiving layer. A cushioning layer will improve adhesion between the image receiving layer and the image forming layer during laser writing, which leads to image quality improvement. Even when dust enters between the heat transfer sheet and the image receiving sheet, the cushioning layer will be deformed in conformity with the contour of the dust to minimize the non-contact area of the two sheets. As a result, possible image defects, such as white spots, can be minimized in size. Furthermore, when the transfer image on the image receiving sheet is re-transferred to printing paper, etc., the image receiving layer is deformable in conformity with the surface roughness of the paper thereby to improve the transfer capabilities. The cushioning layer is also effective in controlling the glossiness of the re-transfer image and providing a better approximation to the final prints.

The cushioning layer producing these effects is preferably formed of materials having a low elastic modulus, materials having rubbery elasticity or thermoplastic resins ready to soften on heating. The cushioning layer preferably has anelasticmodulus of 0.5 MPa to 1.0 GPa, particularlyl MPa to 0.5 GPa, especially 10 to 100 MPa, at room temperature. In order for the cushioning layer to have dust or debris sinking, the cushioning layer preferably has a penetration of 10 or more as measured according to JIS K2530 (25° C., 100 g, 5 seconds). The cushioning layer preferably has a Tg of 80° C. or lower, particularly 25° C. or lower, and a softening point of 50° to 200° C. To control these physical properties, such as a Tg, a plasticizer may be added to the binder forming the cushioning layer.

Binders making up the cushioning layer include rubbers, such as urethane rubber, butadiene rubber, nitrile rubber, acrylic rubber, and natural rubber, polyethylene, polypropylene, polyester, styrene-butadiene copolymers, ethylene-vinyl acetate copolymer, ethylene-acrylic copolymers, vinyl chloride-vinyl acetate copolymers, vinylidene chloride resins, vinyl chloride resins containing a plasticizer, polyamide resins, and phenol resins. The thickness of the cushioning layer is usually 3 to 100 μm, preferably 10 to 52 μm, while varying depending on the kind of the binder and other conditions.

Although the image receiving layer and the cushioning layer must adhere to each other until completion of laser writing, the image receiving layer is preferably releasable when re-transferring the transfer image onto printing paper. To facilitate the release from the cushioning layer, a release layer having a thickness of about 0.1 to 2 μm can be provided between the cushioning layer and the image receiving layer. The thickness of the release layer, which can be adjusted by proper choice of material, should be small so as not to impair the effects of the cushioning layer.

Binders used to form the release layer include thermoplastic resins having a Tg of 65° C. or higher, such as polyolefins, polyester, polyvinyl acetal, polyvinyl formal, polyparabanic acid, polymethyl methacrylate, polycarbonate, ethyl cellulose, nitrocellulose, methyl cellulose, carboxymethyl cellulose, hydroxypropyl cellulose, polyvinyl alcohol, polyvinyl chloride, urethane resins, fluorine resins, polystyrene, acrylonitrile-styrene copolymers, crosslinking products of these resins, polyamide, polyimide, polyether-imide, polysulfone, polyether sulfone, and aramid; and hardened products thereof. Commonly employed hardening agents, such as isocyanate and melamine, can be used for hardening.

The physical properties described above taken into consideration, binders preferred for making the release layer are polycarbonate, acetal resins, and ethyl cellulose for their good storage stability. These binders are particularly suitable for releasing the image receiving layer comprising an acrylic resin binder.

A layer that extremely reduces in adhesion to the image receiving layer on cooling can serve as a release layer. Such a layer comprises hot-melt compounds, such as waxes, and thermoplastic resins (binders) as a main ingredient. Useful hot-melt compounds are described in JP-A-63-193886. Preferred hot-melt compounds include microcrystalline wax, paraffin wax, and carnauba wax. Useful thermoplastic resins include ethylene copolymers, such as ethylene-vinyl acetate copolymers, and cellulosic resins.

If desired, the above-described release layer can contain such additives as higher fatty acids, higher alcohols, higher fatty acid esters, higher fatty acidamides, and higher aliphatic amines.

A layer that melts or softens on heating and undergoes cohesive failure also serves as a release layer. Asupercooling material is preferably incorporated into a release layer of this kind. Useful supercooling materials include poly-ε-caprolactone, polyoxyethylene, benzotriazole, tribenzylamine, and vanillin.

A layer containing a compound which reduces the adhesion to the image receiving layer is also useful as a release layer. Such compounds include silicone resins, e.g., silicone oil; fluorine resins, e.g., Teflon and fluorine-containing acrylic resins; polysiloxane resins; acetal resins, e.g., polyvinyl butyral, polyvinyl acetal, and polyvinyl formal; solid waxes, e.g., polyethylene wax and amide wax; and fluorine type or phosphoric ester type surface active agents.

The release layer is formed by applying a solution or an emulsion (latex) of the above-mentioned material in a solvent to the cushioning layer by various techniques, such as blade coating, roll coating, bar coating, curtain coating, gravure coating, hot-melt extrusion lamination, and the like. Alternatively, the solution or latex may be applied to a carrier film by the above-described application techniques to form a coating film, which is transferred to the cushioning layer.

In an embodiment of the image receiving sheet structure, the image receiving layer may serve as a cushioning layer. In this case, the image receiving sheet may have a layer structure of substrate/cushioning image receiving layer or a layer structure of substrate/undercoating layer/cushioning image receiving layer. It is preferred for the cushioning image receiving layer be provided such that it is ready to be released and transferred to printing paper. In this case, the re-transfer image will have excellent gloss. The cushioning image receiving layer usually has a thickness of 5 to 100 μm, preferably 10 to 40 μm.

It is advisable to provide a backcoating layer on the reverse side (opposite to the image receiving layer side) of the substrate to improve transport properties of the image receiving sheet in a recording apparatus. The improvement on film transport properties is ensured by adding to the back coating layer an antistatic agent (e.g., a surface active agent or fine tin oxide particles) and/or amatting agent (e.g., silicon oxide or polymethyl methacrylate particles). According to necessity, these additives may be added to not only the backcoating layer but other layers including the image receiving layer. The kind of the additive to be added depends on the purpose. Where, for example, a matting agent is needed, a matting agent having an average particle size of 0.5 to 10 μm is added in an amount of about 0.5 to 80% by weight based on the layer to which it is added. Where an antistatic agent is needed, an appropriate compound selected from various surface active agents and electrically conductive agents is added to reduce the surface resistivity of the layer to 10¹² Ω or lower, preferably 10⁹ Ω or less, at 23° C. and 50% RH.

General-purpose polymers can be used as a binder of the backcoating layer, including gelatin, polyvinyl alcohol, methyl cellulose, nitrocellulose, cellulose acetate, aromatic polyamide resins, silicone resins, epoxy resins, alkyd resins, phenol resins, melamine resins, fluorine resins, polyimide resins, urethane resins, acrylic resins, urethane-modified silicone resins, polyethylene resins, polypropylene resins, polyester resins, Teflon resins, polyvinyl butyral resins, vinyl chloride resins, polyvinyl acetate, polycarbonate, organoboron compounds, aromatic esters, polyurethane fluoride, and polyether sulfone. Among them crosslinkable water-soluble resins can be crosslinked to become a binder effective in preventing fall-off of matting agent particles, improving scratch resistance of the backcoating layer, and preventing blocking of image receiving sheets during storage. The crosslinking of the crosslinkable water-soluble resins can be induced by at least one of heat, active light rays, and pressure. In some cases, an arbitrary adhesive layer may be provided between the substrate and the backcoating layer.

Organic or inorganic fine particles can be used as a matting agent added to the backcoating layer. Organic matting agents include particles of polymers obtained by radical polymerization, such as polymethyl methacrylate, polystyrene, polyethylene, and polypropylene; and condensed polymers, such as polyester and polycarbonate.

The backcoating layer preferably has a coating weight of about 0.5 to 5 g/m². A coating film thinner than 0.5 g/m² is difficult to form stably and tends to allow matting agent particles to fall off. If the coating thickness exceeds 5 g/m², the matting agent present therein must have a considerably large particle size to exhibit its effect. Such large particles in the backcoating layer will imprint themselves on an adjacent image receiving layer in a roll form. It would follow that the transfer image on the image receiving layer may suffer from image deficiency or unevenness on account of the imprinted surface unevenness particularly where the image forming layer is very thin.

It is preferred for the matting agent used in the backcoating layer to have a number-average particle size greater than the thickness of the particle-free area of the backcoating layer by 2.5 to 20 μm. It is necessary that matting agent particles of 8 μm or greater be present in the backcoating layer in an amount of 5 mg/m2 or more, particularly 6 to 600 mg/m², thereby to reduce troubles due to foreign matter. In order to prevent image defects attributed to extraordinary large particles and to obtain desired performance with a reduced amount of a matting agent, it is preferred to use a matting agent whose sizes are narrowly distributed with a coefficient of variation σ/rn (obtained by dividing a standard deviation of a distribution by a mean) of 0.3 or smaller, preferably 0.15 or smaller.

The backcoating layer preferably contains an antistatic agent to prevent foreign matter attraction due to triboelectricity. A wide range of known antistatic agents can be used, such as cationic, anionic or nonionic surface active agents, polymeric antistatics, electrically conductive particles, and those described in 11290 no Kagaku Syohin, Kagaku Kogyo Nipposha, 875-876. Of these antistatic agents suitable for use in the backcoating layer are electrically conductive materials, such as carbon black, metal oxides, e.g., zinc oxide, titanium oxide, and tin oxide, and organic semiconductors. Electrically conductive fine particles are particularly preferred, for they do not separate from the backcoating layer to exert stable and environment-independent antistatic effects.

The backcoating layer can further contain various activators or release agents, such as silicone oil and fluorine resins, for improving coating capabilities or releasability. It is especially advisable to provide the above-described backcoating layer where the cushioning layer and the image receiving layer have a softening point of 70° C. or lower measured by thermochemical analysis (hereinafter referred to as a TMA softening point). The TMA softening point is obtained by observing the phase of a sample being heated at a given rate of temperature rise with a given load applied thereto. In the present invention, the temperature at which the phase of the sample begins to change is defined as a TMA softening point. Measurement of a TMA softening point can be made with, for example, Thermoflex supplied by Rigaku Denki-Sha.

In carrying out thermal transfer recording, the heat transfer sheet and the image receiving sheet are superposed on each other to prepare a laminate with the image forming layer of the former and the image receiving layer of the latter in contact.

A laminate of the heat transfer sheet and the image receiving sheet can be prepared through various methods. For example, the two sheets superposed on each other in the above-described manner are passed through a pair of pressure and heat rollers. The heating temperature of the rollers is 160° C. or lower, preferably 130° C. or lower.

Another method of preparing the laminate is vacuum holding, which has previously been described with respect to the recording apparatus. That is, the image receiving sheet is the first to be held by suction around a recording drum having a number of suction holes. The heat transfer sheet, which is designed to be slightly larger in size than the image receiving sheet, is then held on the image receiving sheet while the entrapped air is pressed out with a squeegee roller. Still another method of preparing the laminate comprises pulling the image receiving sheet to a recording drum, mechanically fixing the sheet onto the drum, and then fixing the heat transfer sheet thereon in the same manner as for the image receiving sheet. The vacuum holding method is especially advantageous in that temperature control (as required for heat rollers) is unnecessary, and uniform contact of the two sheets is accomplished quickly.

### EXAMPLES

The present invention will now be illustrated in greater detail with reference to Examples, but it should be understood that the invention is not deemed to be limited thereto. Unless otherwise noted, all the parts and percents are by weight.

### Example 1

### 1. Preparation of Heat Transfer Sheet (C)

1-1. Formation of Backcoating Layer

A coating composition for 1st backcoating layer was prepared according to the following formulation.

Formulation of coating composition for 1st backcoating layer:

| | | |
|---|---|---|
| Aqueous dispersion of acrylic resin (Jurymer | 2 | parts |
| ET410, available from Nihon Junyaku Co., Ltd.; | | |
| solid content: 20%) | | |
| Antistatic agent (waterborne dispersion of tin | 7.0 | parts |
| oxide-antimony oxide; average particle size: 0.1 μm; | | |
| solid content: 17%) | | |
| Polyoxyethylene phenyl ether | 0.1 | part |
| Melamine compound (Sumitex Resin M-3, from | 0.3 | parts |
| Sumitomo Chemical Co., Ltd.) | | |
| Distilled water | to make 100 | parts |

A biaxially stretched polyethylene terephthalate (PETP) film having a thickness of 75 μm and an Ra of 0.01 μm on both sides was subjected to corona discharge treatment on one side. The coating composition for 1st backcoating layer was applied to the corona discharge treated side of the substrate to a dry thickness of 0.03 μm and dried at 180° C. for 30 seconds to form a first backcoating layer. The substrate used had a Young's modulus of 450 kg/mm² (≈4.4 GPa) in the MD and of 500 kg/mm² (≈4.9 GPa) in the TD; an F-5 value of 10 kg/mm² (p98 MPa) in the MD and of 13 kg/mm² (≈127.4 MPa) in the TD; a thermal shrinkage percentage of 0.3% in the MD and of 0.1% in the TD both after heating at 100° C. for 30 minutes; a breaking strength of 20 kg/mm² (≈196 MPa) in the MD and of 25 kg/mm² (≈245 MPa) in the TD; and an elastic modulus of 400 kg/mm² (≈3.9 GPa).

A coating composition for second backcoating layer was prepared according to the following formulation.

Formulation of coating composition for 2nd backcoating layer:

| | | |
|---|---|---|
| Polyolefin (Chemipearl S-120, available from Mitsui | 3.0 | parts |
| Chemicals, Inc.; solid content: 27%) | | |
| Antistatic agent (waterborne dispersion of tin | 2.0 | parts |
| oxide-antimony oxide; average particle size: 0.1 μm; | | |
| solid content: 17%) | | |
| Colloidal silica (Snowtex C, available from Nissan | 2.0 | parts |
| Chemical Industries, Ltd.; solid content: 20%) | | |
| Epoxy compound (Denacol EX-614B, from Nagase | 0.3 | parts |
| Chemical Co., Ltd.) | | |
| Distilled water | To make 100 | parts |

The coating composition for second backcoating layer was applied to the first backcoating layer to a dry thickness of 0.03 μm and dried at 170° C. for 30 seconds to form a second backcoating layer.

1-2. Formation of Light-Heat Conversion Layer

The components shown below were mixed while agitating with a stirrer to prepare a coating composition for light-heat conversion layer.

Formulation of coating composition for light-heat conversion layer:

| | | |
|---|---|---|
| Infrared absorbing dye (compound (I′-17) of formula (B): | 7.6 | parts |
| Polyamide-imide of formula (A) wherein R is a linking | 29.3 | parts |
| group (6) | | |
| Exxon Naphtha | 5.8 | parts |
| N-Methylpyrrolidone | 1500 | parts |
| Methyl ethyl ketone (MEK) | 360 | parts |
| Fluorine type surface active agent (Magafac F-176PF, from | 0.5 | parts |
| Dainippon Ink & Chemicals, Inc.) | | |
| Matting agent dispersion | 14.1 | parts |

The matting agent dispersion used in the above formulation was prepared as follows. A mixture of 10 parts of true spherical silica powder having an average particle size of 1.5 μm (Seahostar KE-P150, from Nippon Shokubai Co., Ltd.), 2 parts of an acrylic ester-styrene copolymer as a dispersant (Joncryl 611, from Johnson Polymer Co., Ltd.), 16 parts of MEK, and 64 parts of N-methylpyrrolidone was put in a 200 ml polyethylene container together with 30 parts of glass beads having a diameter of 2 mm. The mixture in the container was dispersed in a paint shaker supplied by Toyo Seiki Co., Ltd. for 2 hours to prepare a matting agent dispersion.

The resulting coating composition was applied to the other side of the PETP film with a wire bar and dried in an oven at 120° C. for 2 minutes to form a light-heat conversion layer. The light-heat conversion layer had an optical density (OD_{LH}) of 0.93 at 808 nm as measured with a UV spectrophotometer UV-240 supplied by Shimadzu Corp. A cut area of the light-heat conversion layer was observed under a scanning electron microscope (SEM) to find that the average layer thickness (T_{LH}) was 0.3 μm. The surface gloss of the light-heat conversion layer was 90 (Gs (60° C.) as specified in JIS Z8741).

1-3. Formation of Trapping Layer (Intermediate Layer)

A coating composition for trapping layer was prepared by mixing the following components by agitating with a stirrer.

Formulation of coating composition for trapping layer:

| | | |
|---|---|---|
| MEK | 38.4 | parts |
| Cyclohexanone | 9.6 | parts |
| Modified cellulose (AS-MG, from Shin-Etsu Chemical Co., | 0.5 | parts |
| Ltd.) | | |
| Surface active agent (Megafac F-176PF, from Dainippon | 0.01 | part |
| Ink & Chemicals, Inc.) | | |

The resulting coating composition was applied to the light-heat conversion layer with a wire bar and dried in an oven at 120° C. for 2 minutes to form a trapping layer having a thickness of 0.1 μm in average.

1-4. Formation of Image Forming Layer

The components shown below were mixed by agitating with a stirrer to prepare a coating composition for cyan image forming layer.

Formulation of cyan image forming layer:

| | | |
|---|---|---|
| Potassium N-perfluorooctanesulfonyl-N-propylglycine | 0.12 | parts |
| (surface active agent) | | |
| Surfynol 504 (surface active agent, available fromNisshin | 0.30 | parts |
| Chemical Industry Co., Ltd.) | | |
| Ion exchanged water | 208 | parts |
| Vinyblan 2561 (aqueous latex of a styrene-acrylic | 17.1 | parts |
| copolymer resin; from Nisshin Chemical Industry Co., | | |
| Ltd.; MFT: 0° C.; Tg: −36° C.) | | |
| Himicron K Blue 6227 (available from Mikuni color Ltd.) | 8.4 | parts |

The coating composition for a cyan image forming layer was applied to the trapping layer with a wire bar for 1 minute and dried in an oven at 100° C. for 2 minutes to form a cyan image forming layer. There was thus obtained a heat transfer sheet (C) having a layer structure of substrate/light-heat conversion layer/trapping layer/cyan image forming layer in the order described. The cyan image forming layer had a thickness of 0.45 μm in average and a surface hardness of 200 g or more as measured with a sapphire stylus.

### 2. Preparation of Image Receiving Sheet

A coating composition for cushioning layer and a coating composition for image receiving layer were prepared according to the following formulations.

Formulation of coating composition for cushioning layer:

| | | |
|---|---|---|
| Vinyl chloride-vinyl acetate copolymer as binder (MPR-TSL, | 20 | parts |
| available from Nisshin Chemical Industry Co., Ltd.) | | |
| Plasticizer (Paraplex G-40, available from The C. P. Hall | 10 | parts |
| Co.) | | |
| Fluorine-type surface active agent (Megafac F-177, | 0.5 | parts |
| available from Dainippon Ink & Chemicals, Inc.) | | |
| Antistatic agent (SAT-5 Supper (IC), quaternary ammonium | 0.3 | parts |
| salt available from Nihon Jynyaku Co., Ltd.) | | |
| MEK | 60 | parts |
| Toluene | 10 | parts |
| N,N-Dimethylformamide | 3 | parts |

Formulation of coating composition for image receiving layer:

| | | |
|---|---|---|
| Polyvinyl butyral (S-LEC B BL-SH, available from Sekisui | 8 | parts |
| Chemical Co., Ltd.) | | |
| Antistatic agent (Sanstat 2012A, available from Sanyo | 0.7 | parts |
| Chemical Industries, Ltd.) | | |
| Surface active agent (Megafac F-176PF, from Dainippon | 0.1 | part |
| Ink & Chemicals, Inc.; solid content: 20%) | | |
| n-Propyl alcohol | 20 | parts |
| Methanol | 20 | parts |
| 1-Methoxy-2-propanol | 50 | parts |

The coating composition for cushioning layer was applied to a white PETP film having a thickness of 130 μm (Lumirror #130E58, available from Toray Industries, Inc.) with a small-width applicator to a dry thickness of about 20 μm and dried to form a cushioning layer. The coating composition for image receiving layer was applied thereon to a dry thickness of about 2 μm and dried to form an image receiving layer. The white PETP film used as a substrate is a void-containing PETP layer (thickness: 116 μm; void: 20%) laminated on both sides thereof with a titanium oxide-containing PETP layer (thickness: 7 μm; titanium oxide content: 2%) (total thickness: 130 μm; specific gravity: 0.8).

Each of the resulting heat transfer sheet (C) and the image receiving sheet was wound into a roll and stored at room temperature for one week before image formation.

The resulting image receiving layer had an Ra of 0.02 μm (a preferred Ra is 0.01 to 0.4 μm), a surface waviness of 1.2 μm (a preferred surface waviness is 2 μm or smaller), a smooster value of 0.8 mmHg (≈0.11 kPa) (at 23° C. and 55%RH), a coefficient of static friction of 0.37 (a preferred coefficient of static friction is 0.8 or smaller), a surface energy of 29 mJ/m², and a water contact angle of 85° C.

### Examples 2 to 4 and Comparative Examples 1 to 3

Heat transfer sheets (C) were prepared in the same manner as in Example 1, except for using each of the waterborne latices shown in Table 1 below as a binder of the image forming layer.

Each of the resulting cyan image forming materials was evaluated as follows. Image formation by thermal transfer and re-transfer to printing paper were carried out in accordance with the scheme of the system configuration shown in FIG. 4, in which Luxel FINALPROOF 5600 was used as a laser thermal transfer recording apparatus.

A56 cm wide and 79 cm long cut sheet of the image receiving sheet was held by suction on a recording drum having a diameter of 380 mm (a preferred drum diameter is 360 mm or greater) through suction holes of 1 mm in diameter of the drum (one hole per 3 cm by 8 cm area). A 61 cm wide and 84 cm long cut sheet of the heat transfer sheet (C) was superposed on the image receiving sheet with its four edges extending evenly from the edges of the image receiving sheet while being squeegeed with a squeegee roller so that the two sheets were brought into intimate contact while allowing entrapped air to escape and be sucked. The degree of vacuum of the drum, measured with the suction holes closed, was (atmospheric pressure minus 150) mmHg (≈81.13 kPa). The drum was rotated, and the heat transfer sheetwas scanned with semiconductor laser light having a wavelength of 808 nm and a spot diameter of 7 μm on the surface of the light-heat conversion layer. The laser was moved in a direction (slow scan direction) perpendicular to the drum rotating direction (fast scan direction) to carry out recording of a solid cyan image. The laser recording conditions are shown below. The light source was multibeams arranged in a two-dimensional parallelogram consisting of five lines of laser beams arrayed in the fast scan direction and three rows of laser beams arrayed in the slow scan direction.

Laser power: 110 mW

Drum rotation: 500 rpm

Slow scanning pitch: 6.35 μm

Environment: (1) 20° C., 40% RH, (2) 23° C., 50% RH, (3) 26° C., 65% RH

The recorded image size was 515 mm wide and 728 mm long, and the resolution was 2600 dpi.

After completion of laser recording, the laminate was removed from the drum, and the heat transfer sheet (C) was stripped by hand off the image receiving sheet to transfer the solid cyan image to the image receiving sheet. The image on the image receiving sheet was then re-transferred to a sheet of printing paper (Reflection II, available from Stora Enso) by use of a thermal transfer apparatus having the following specification to obtain a solid cyan image. The dynamic frictional coefficient of the insertion table against a PETP film (the substrate of the image receiving sheet) was 0.1 to 0.7. The speed of transporting the laminate (image receiving sheet and the printing paper) was 15 to 50 mm/sec. The heat rolls were made of a material having a Vickers hardness of 70 (a preferred Vickers hardness of the material is 10 to 100).

It was proved as a result that all the heat transfer sheets provide a high quality image with a stable transfer density even in high-energy laser recording using a multibeam laser writing system under various temperature and humidity conditions.

The heat transfer sheets of Examples and Comparative Examples were also evaluated as follows. The results obtained are shown in Table 1.

1) Surface Condition of Image Forming Layer

The surface condition of the cyan image forming layer of each heat transfer sheet (C) was observed with the naked eye and rated according to the following standard.

A: Uniform

B: Almost uniform

C: Slight thickness variation

D: Non-uniform with considerable thickness variation

2) Dot Reproduction

Dot reproduction in the transferred image was evaluated under microscopic observation and rated according to the following standard.

A: Sharp dots are reproduced over a full range from highlights to shadows.

B: Substantially sharp dots are reproduced over a full range from highlights to shadows.

C: Dots are reproduced over a full range from highlights to shadows, but many dots are found missing.

D: Dots reproduction is unsatisfactory.

TABLE 1

| | | MFT | Tg | Surface | Dot |
|---|---|---|---|---|---|
| | Aqueous Binder | (° C.) | (° C.) | Condition | Re-production |
| Example 1 | Vinyblan 2561 | 0 | −36 | A | B |
| Example 2 | Vinyblan 2760*¹ | 0 | −25 | B | B |
| Example 3 | Vinyblan 2770*² | 18 | 15 | A | B |
| Example 4 | Vinyblan 2598*³ | 35 | 33 | B | B |
| Comp. | Vinyblan 2647*⁴ | 80 | 78 | D | D |
| Example 1 | | | | | |
| Comp. | Sumikaflex | 0 | 0 | D | D |
| Example 2 | S456*⁵ | | | | |
| Comp. | Nippol 2570X5*⁶ | — | −18 | C | D |
| Example 3 | | | | | |

*¹Waterborne latex of styrene-acrylic copolymer resin from Nisshin Chemical Industry Co., Ltd. (hereinafter, “Nisshin”).
*²Waterborne latex of acrylic resin from Nisshin.
*³Waterborne latex of acrylic resin from Nisshin.
*⁴Waterborne latex of acrylic resin from Nisshin.
*⁵Waterborne latex of ethylene-vinyl acetate copolymer resin from Sumitomo Chemical Co., Ltd.
*⁶Waterborne latex of SBR from Zeon Corp.

As is apparent from Table 1, the image forming materials of the present invention are satisfactory in both coating surface condition of image forming layer and dot reproduction in transferred image.

It has also confirmed that the image forming materials of the invention are applicable to an on-demand image recording system and capable of providing an image with clear hue and good dot reproduction in the on-demand system as well.

The present invention provides a thermal transfer image forming material capable of recording a high quality image. The image forming layer of the image forming material has a satisfactory surface condition and exhibits excellent image forming performance in sensitivity and image quality. The technique of the invention is applicable to on-demand image recording, making it possible to record an image of desired color when needed without holding a large stock of heat transfer sheets of various colors.

This application is based on Japanese Patent application JP 2003-58581, filed Mar. 5, 2003, the entire content of which is hereby incorporated by reference, the same as if set forth at length.

What is claimed is:

1. A heat transfer sheet comprising a substrate, a light-heat conversion layer, and an image forming layer, wherein the image forming layer contains as a binder at least one of an acrylic resin and a styrene-acrylic copolymer resin, the acrylic resin and the styrene-acrylic copolymer resin having a glass transition temperature of 50° C. or lower and a minimum film-forming temperature of 50° C. or lower.

2. The heat transfer sheet according to claim 1, wherein the acrylic resin and the styrene-acrylic copolymer resin have a glass transition temperature of 20° C. or lower.

3. The heat transfer sheet according to claim 1, wherein the acrylic resin and the styrene-acrylic copolymer resin have a minimum film-forming temperature of 20° C. or lower.

4. The heat transfer sheet according to claim 1, further comprising an intermediate layer formed farther from the substrate than the light-heat conversion layer.

5. An image forming material comprising an image receiving sheet containing an image receiving layer and the heat transfer sheet according to claim 1, the heat transfer sheet being adapted to be superposed on the image receiving sheet with the image forming layer facing the image receiving layer and irradiated with laser light to transfer the irradiated area of the image forming layer to the image receiving layer to record an image on the image receiving sheet.

6. The image forming material according to claim 5, wherein the image has a size of 515 mm by 728 mm or larger.

7. The image forming material according to claim 5, wherein the image has a size of 594 mm by 841 mm or larger.

8. A method for forming an image comprising the steps of:
superposing the heat transfer sheet according to claim 1 on the image receiving sheet according to claim 5 with the image forming layer of the heat transfer sheet facing the image receiving layer of the image receiving sheet,
imagewise irradiating the superposed heat transfer sheet with laser light,
and transferring the irradiated area of the image forming layer to the image receiving layer of the image receiving sheet in a form of a thin film to record an image.

9. A coating composition for forming an image forming layer on a laminate sheet comprising a substrate, a light-heat conversion layer, and an intermediate layer in this order, the coating composition being adapted to be applied to the intermediate layer on demand for image recording, which contains a waterborne latex of at least one of an acrylic resin and a styrene-acrylic copolymer resin, the acrylic resin and the styrene-acrylic copolymer resin having a glass transition temperature of 50° C. or lower and a minimum film-forming temperature of 50° C. or lower.

10. The coating composition according to claim 9, wherein the acrylic resin and the styrene-acrylic copolymer resin have a glass transition temperature of 20° C. or lower.

11. The coating composition according to claim 9, wherein the acrylic resin and the styrene-acrylic copolymer resin have a minimum film-forming temperature of 20° C. or lower.

12. A method for forming an image on demand comprising the steps of:
applying the coating composition according to claim 9 to a laminate sheet comprising a substrate, a light-heat conversion layer, and an intermediate layer in this order to form an image forming layer on the intermediate layer thereby to prepare a heat transfer sheet,
superposing the heat transfer sheet on an image receiving sheet having an image receiving layer with the image forming layer facing the image receiving layer,
imagewise irradiating the superposed heat transfer sheet with laser light, and
transferring the irradiated area of the image forming layer to the image receiving layer of the image receiving sheet in a form of a thin film to record an image.
